(19) United States
(12) Patent Application Publication
(10) Pub. No.: US 2015/0142537 A1
(43) Pub. Date: May 21, 2015

(54) RECEIVING PRODUCT/SERVICE INFORMATION AND CONTENT BASED ON A CAPTURED IMAGE

(71) Applicant: Verizon Patent and Licensing Inc., Basking Ridge, NJ (US)

(72) Inventor: Bruce SEARS, Rockwall, TX (US)

(73) Assignee: Verizon Patent and Licensing Inc., Basking Ridge, NJ (US)

(21) Appl. No.: 14/082,889

(22) Filed: Nov. 18, 2013

(51) Int. Cl. G06Q 30/02; G06Q 30/06

(52) U.S. Cl. CPC G06Q 30/0252; G06Q 30/0261; G06Q 30/0259; G06Q 30/0633
USPC 705/14.5

(57) ABSTRACT

A device receives an image captured by a user device at an event or at an event location, and analyzes the captured image to determine the event or the event location. The device analyzes the captured image to determine an entity associated with the event or the event location, and determines, based on the captured image, a product, a service, and/or content associated with the event, the event location, and/or the entity. The device provides, to the user device, information associated with the product, the service, and/or the content, where the information identifies a location at the event location from which to purchase the product, the service, and/or the content.

### BACKGROUND

Entities such as colleges, professional sports teams, entertainers, etc. typically offer a variety of products, services, and/or content via web sites dedicated to the entities. For example, a college football team may offer apparel (e.g., shirts, hats, pants, jackets, etc.); content (e.g., videos, images, audio, newsletters, etc.); and other products, services, and/or content associated with the college football team via a web site associated with the college football team. Purchasing such products, services, and/or content via the web site may require a user to locate the web site, via a user device (e.g., a computer), and search for particular products, services, and/or content of interest to the user.

### BRIEF DESCRIPTION OF THE DRAWINGS

FIGS. 1A-1C are diagrams of an overview of example implementations described herein;

FIG. 2 is a diagram of an example environment in which systems and/or methods described herein may be implemented;

FIG. 3 is a diagram of example components of a device that may correspond to one or more of the devices of the environment depicted in FIG. 2;

FIG. 4 is a flow chart of an example process for receiving and configuring an application for a user device;

FIG. 5 is a diagram of an example user interface that may be used in connection with the example process shown in FIG. 4;

FIG. 6 is a flow chart of an example process for receiving products, services, and/or content associated with an entity based on a captured image;

FIGS. 7A-7G are diagrams of an example relating to the example process shown in FIG. 6;

FIG. 8 is a flow chart of an example process for receiving event information associated with an entity based on a captured image;

FIGS. 9A-9D are diagrams of an example relating to the example process shown in FIG. 8;

FIG. 10 is a flow chart of an example process for receiving products, services, and/or content associated with an event and/or an event location based on a captured image; and

FIGS. 11A-11F are diagrams of an example relating to the example process shown in FIG. 10.

### DETAILED DESCRIPTION OF PREFERRED EMBODIMENTS

The following detailed description refers to the accompanying drawings. The same reference numbers in different drawings may identify the same or similar elements.

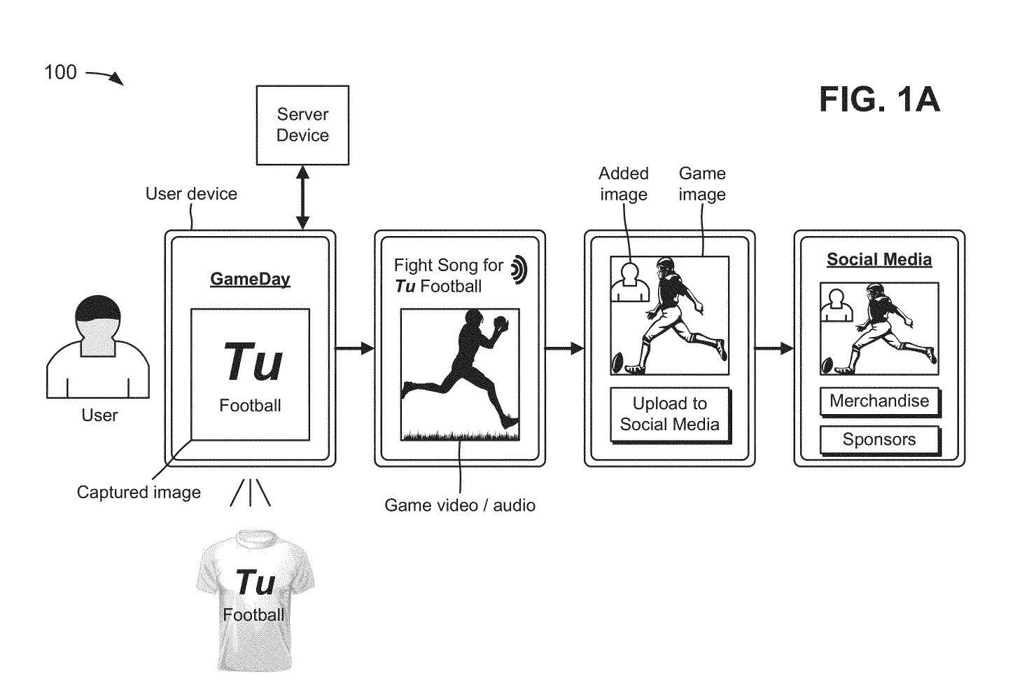

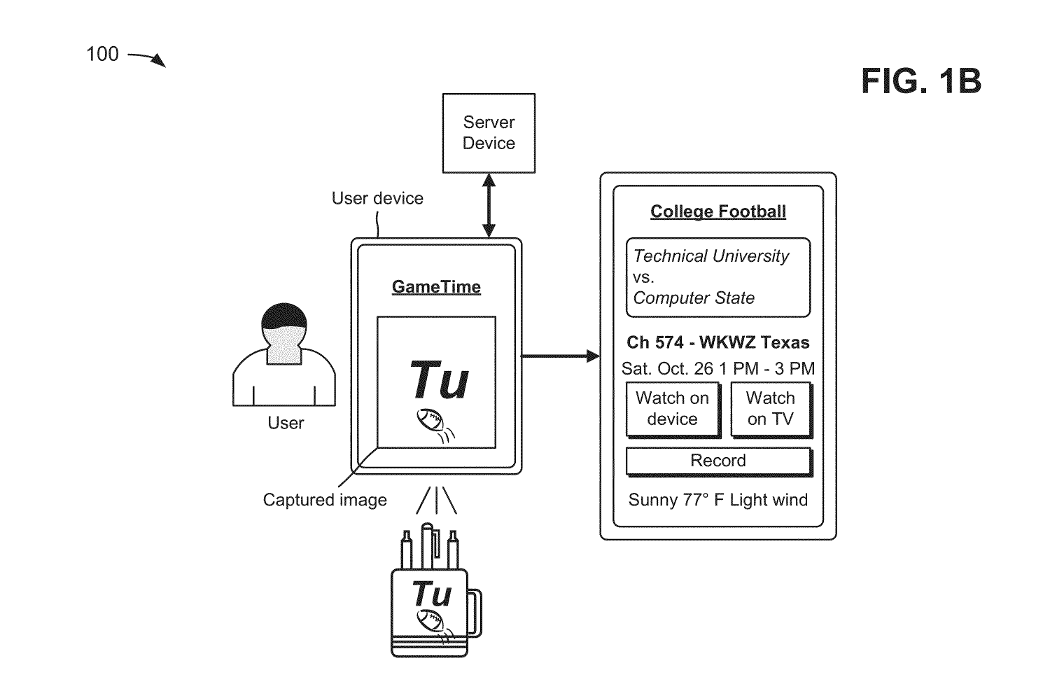

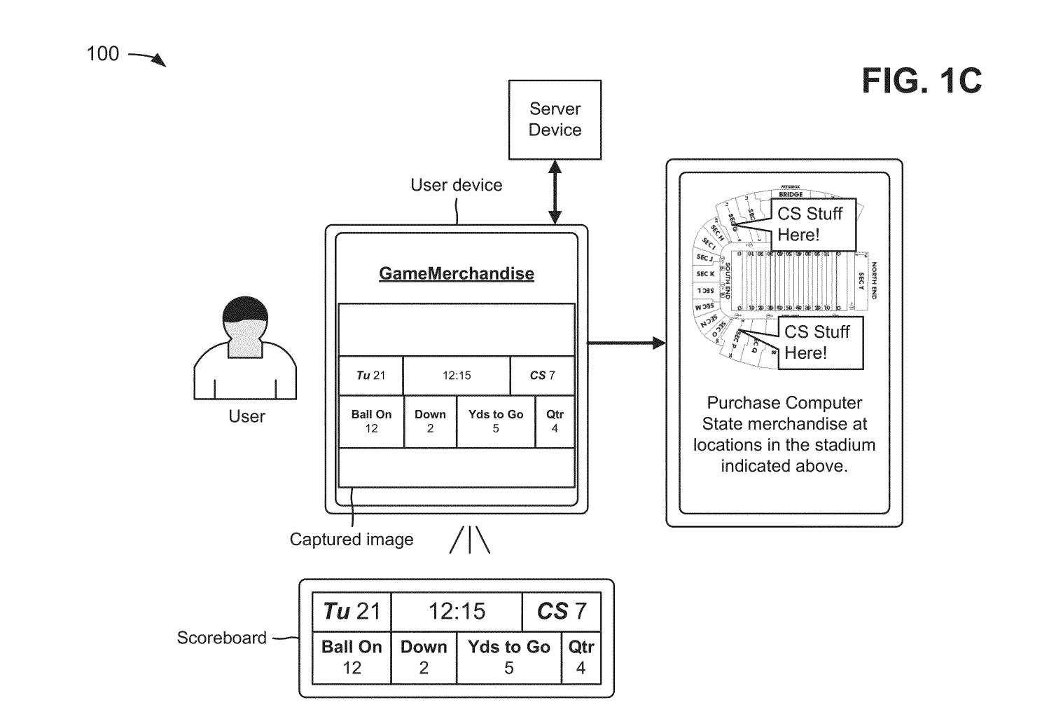

FIGS. 1A-1C are diagrams of an overview of example implementations 100 described herein. As shown in FIG. 1A, assume that a user is associated with a user device that communicates with a server device. Further, assume that the user device includes an application that enables the user to quickly access products, services, and/or content offered by an entity based on an image captured by the user device. For example, as shown in FIG. 1A, the user may utilize a camera of the user device to capture an image of words (e.g., “TU Football”) provided on a shirt. The application may provide the captured image of the words to the server device, and the server device may determine the words based on the captured image. The server device may determine that the words are associated with a particular entity, such as the Technical University (TU) football team. Based on this determination, the server device may provide an audio file of the TU football fight song to the user device, and the user device may play the audio file for the user, as further shown in FIG. 1A.

The server device may also provide, to the user device, a video clip and/or an audio clip associated with a most recent game played by the TU football team. The user device may play the video clip and/or the audio clip of the game for the user. The server device may provide, to the user device, a game image from a most recent game or a most famous game (e.g., a championship game) played by the TU football team. The user device may display the game image, and the application may enable the user device camera to capture an image to add to the game image. For example, the user may utilize the camera to capture an image of the user or the user's friend. As further shown in FIG. 1A, the application may enable the user to upload or post the combined images (e.g., the added image and the game image) to a social media account associated with the user. The application may cause the user device to post the combined images to the social media account. The server device may provide, to the user device, information associated with merchandise and/or sponsors of the TU football team, and the user device may display the information to the user.

Now assume that the user utilizes the camera of the user device to capture an image of a TU Football logo provided on a coffee mug, as shown in FIG. 1B. The application may provide the captured image of the logo to the server device, and the server device may determine that the logo is associated with the TU football team. Based on this determination, the server device may search for an upcoming game for the TU football team. The server device may provide, to the user device, information associated with the upcoming game, and the user device may display the information to the user. For example, as further shown in FIG. 1B, the user device may display information identifying an opponent (e.g., Computer State) of the TU football team; time and date information associated with the game; broadcast information (e.g., a television channel and network broadcasting the game) associated with the game; options to watch the game on the user device or on television; an option to record the game; weather information associated with the game; etc.

Now assume that the user brings the user device to a stadium where the game between Technical University (Tu) and Computer State (CS) is being played. Further, assume that the user utilizes the camera of the user device to capture an image of a scoreboard provided at the stadium, as shown in FIG. 1C. The application may provide the captured image of the scoreboard to the server device, and the server device may determine that the scoreboard is associated with the Computer State football team. In some implementations, the server device may include a profile of the user that indicates that the user is a Computer State football fan rather than a Technical University football fan. Based on the determination that the scoreboard is associated with the Computer State football team, the server device may determine that products, services, and/or content associated with the Computer State football team are available for sale in the stadium. The server device may provide, to the user device, information associated with such products, services, and/or content, and the user device may display the information to the user. For example, as further shown in FIG. 1C, the user device may display an image of the stadium along with information identifying locations, within the stadium where Computer State products, services, and/or content can be purchased by the user. In some implementations, the server device may provide, to the user device, an option to purchase online tickets for upcoming Computer State games. If the user is not located in the stadium and wants to attend an upcoming Computer State game, the user may utilize the user device to purchase the tickets online. In some implementations, the products, services, and/or content offered to the user may depend on a score of the game displayed on the scoreboard. For example, if Computer State is winning by a large margin late in the game, the user may be offered products, services, and/or content indicating that Computer State beat Technical University.

The systems and/or methods described herein may enable a user of a user device to quickly and easily locate information associated with products, services, and/or content of an entity based on a captured image associated with the entity. The systems and/or methods may also enable the user to quickly retrieve event information (e.g., game information) for the entity based on the captured image.

While the systems and/or methods are primarily described in the context of sports teams and/or sporting events, the systems and/or methods may also be applied in other types of contexts. For example, in some implementations, the systems and/or methods may enable a user of a user device to capture an image associated with an Internet radio station, and to automatically stream the Internet radio station to the user device based on the captured image. In some implementations, when the user utilizes the user device to capture an image of a movie trailer, the systems and/or methods may provide a list of theaters showing the movie that are closest to the user, based on the captured image.

In some implementations, when the user utilizes the user device to capture an image of a handwritten name of a television show, the systems and/or methods may provide a time and a date associated with a next episode of the television show, based on the captured image. In some implementations, when the user utilizes the user device to capture an image of a product in a television commercial, the systems and/or methods may automatically connect the user device with a web site that describes and/or sells the product, based on the captured image. In some implementations, when the user (e.g., while waiting in line at a restaurant) utilizes the user device to capture an image of an item on the restaurant's menu, the systems and/or methods may provide pictures of the item to the user device and/or may place an order for the item, based on the captured image.

An entity, as the term is used herein, is to be broadly interpreted to include an organization (e.g., a company, a government agency, a university, a sports team, etc.); a person(s) (e.g., a singer, a band, an actor or actress, a cartoon character, etc.); or another thing that is associated with products, services, and/or content.

A product, as the term is used herein, is to be broadly interpreted to include anything that may be marketed or sold as a commodity or a good. For example, a product may include clothing, bread, coffee, bottled water, milk, soft drinks, pet food, beer, fuel, meat, fruit, automobiles, clothing, etc.

A service, as the term is used herein, is to be broadly interpreted to include any act or variety of work done for others (e.g., for compensation). For example, a service may include a repair service (e.g., for a product), a warranty (e.g., for a product), a telecommunication service (e.g., a telephone service, an Internet service, a network service, a radio service, a television service, a video service, etc.), an automobile service (e.g., for selling automobiles), a food service (e.g., for a restaurant), a banking service, a lodging service (e.g., for a hotel), etc.

Content, as used herein, is to be broadly interpreted to include video, audio, images, text, software downloads, and/or combinations of video, audio, images, text, and software downloads.

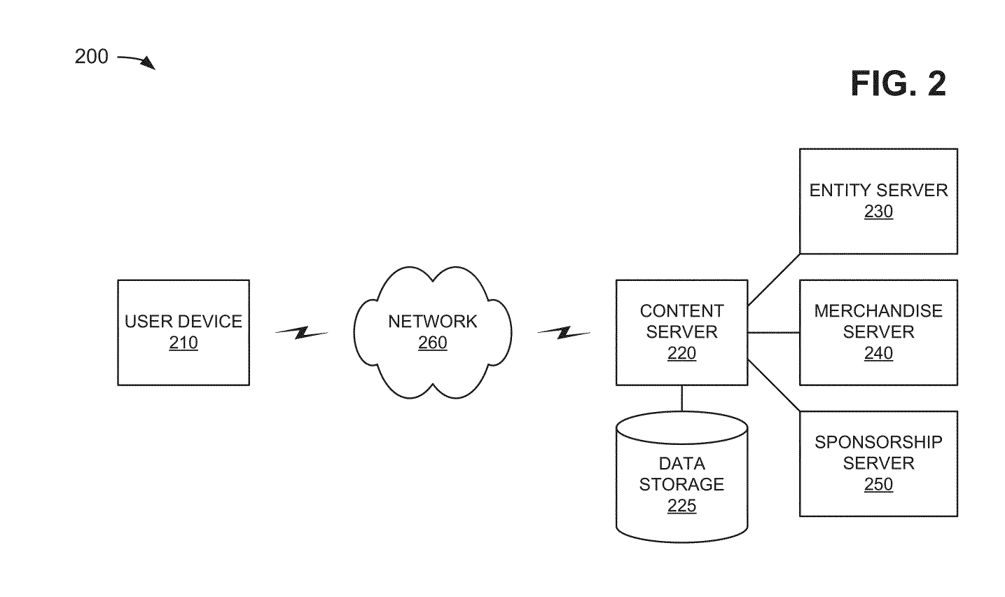

FIG. 2 is a diagram of an example environment 200 in which systems and/or methods described herein may be implemented. As illustrated, environment 200 may include a user device 210, a content server 220, data storage 225, an entity server 230, a merchandise server 240, a sponsorship server 250, and a network 260. Devices/networks of environment 200 may interconnect via wired connections, wireless connections, or a combination of wired and wireless connections.

User device 210 may include a device that is capable of communicating over network 260 with content server 220, data storage 225, entity server 230, merchandise server 240, and/or sponsorship server 250. In some implementations, user device 210 may include a radiotelephone; a personal communications services (PCS) terminal that may combine, for example, a cellular radiotelephone with data processing and data communications capabilities; a smart phone; a personal digital assistant (PDA) that can include a radiotelephone, a pager, Internet/intranet access, etc.; a laptop computer; a tablet computer; a desktop computer; a workstation computer; a personal computer; a landline telephone; or another type of computation and communication device.

Content server 220 may include one or more personal computers, workstation computers, server devices, or other types of computation and communication devices. In some implementations, content server 220 may receive an image captured by user device 210, and may identify an entity based on the captured image. Content server 220 may utilize the identified entity to provide information associated with products, services, and/or content to user device 210. In some implementations, content server 220 may provide information associated with an upcoming event (e.g., a game, a concert, a show, a movie, etc.) for the identified entity to user device 210. In some implementations, content server 220 may provide, to user device 210, information associated with products, services, and/or content of the identified entity that are available at a location of user device 210.

Data storage 225 may include one or more storage devices that store information in one or more data structures, such as databases, tables, lists, trees, etc. In some implementations, data storage 225 may store information, such as information associated with products, services, and/or content, received from entity server 230, merchandise server 240, and/or sponsorship server 250. In some implementations, data storage 225 may store information associated with events (e.g., games, concerts, shows, movies, etc.) for one or more entities. In some implementations, data storage 225 may be included within content server 220.

Entity server 230 may include one or more personal computers, workstation computers, server devices, or other types of computation and communication devices. In some implementations, entity server 230 may be associated with one or more entities, and may include information associated with products, services, and/or content of the one or more entities. In some implementations, entity server 230 may provide the information associated with the products, the services, and/or the content of the one or more entities to content server 220 and/or data storage 225. For example, if entity server 230 is associated with a profession sports team, entity server 230 may provide video of the team's games, information associated with official team merchandise, team information (e.g., a roster, a schedule, etc.), etc. to content server 220.

Merchandise server 240 may include one or more personal computers, workstation computers, server devices, or other types of computation and communication devices. In some implementations, merchandise server 240 may include information about merchandise associated with one or more entities. In some implementations, merchandise server 240 may provide the information about the merchandise associated with the one or more entities to content server 220 and/or data storage 225. For example, merchandise server 240 may sell apparel (e.g., shirts, hats, sweatshirts, etc.) for one or more teams that are members of a collegiate sports league. In such an example, merchandise server 240 may provide information (e.g., images, prices, shipping options, etc.) associated with the apparel to content server 220.

Sponsorship server 250 may include one or more personal computers, workstation computers, server devices, or other types of computation and communication devices. In some implementations, sponsorship server 250 may include information about sponsors associated with one or more entities. In some implementations, sponsorship server 250 may provide the information about the sponsors associated with the one or more entities to content server 220 and/or data storage 225. For example, sponsorship server 250 may generate advertisements for sponsors of the one or more entities, and may provide the advertisements to content server 220.

Network 260 may include a network, such as a local area network (LAN), a wide area network (WAN), a metropolitan area network (MAN), a telephone network, such as the Public Switched Telephone Network (PSTN) or a cellular network, an intranet, the Internet, a fiber optic network, or a combination of networks.

The number of devices and/or networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

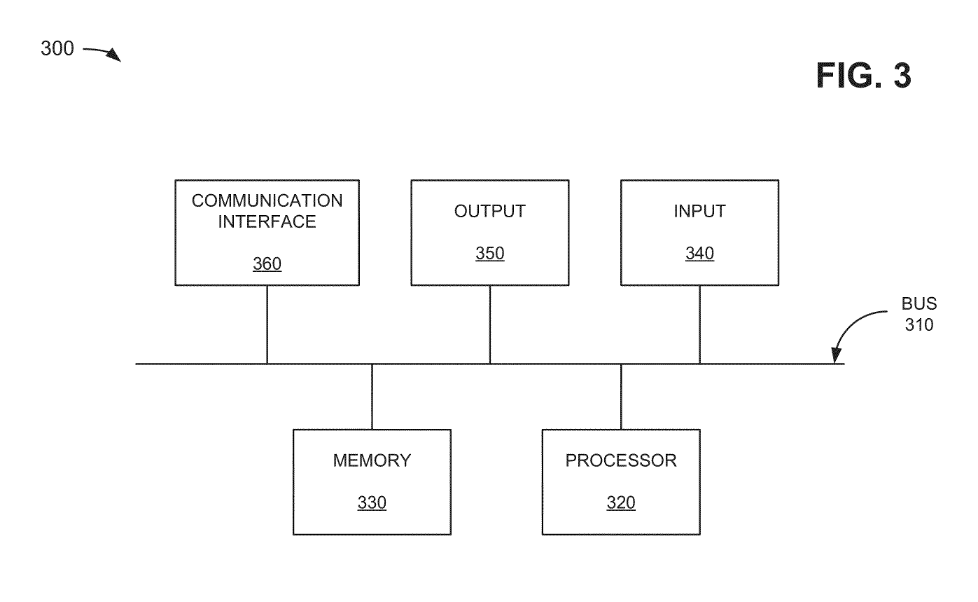

FIG. 3 is a diagram of example components of a device 300 that may correspond to one or more of the devices of environment 200. In some implementation, one or more of the devices of environment 200 may include one or more devices 300 or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit, etc.), a microprocessor, and/or any processing component (e.g., a field-programmable gate array (FPGA), an application-specific integrated circuit (ASIC), etc.) that interprets and/or executes instructions, and/or that is designed to implement a particular function. In some implementations, processor 320 may include multiple processor cores for parallel computing. Memory 330 may include a random access memory (RAM), a read only memory (ROM), and/or another type of dynamic or static storage component (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a switch, etc.). Output component 350 may include a component that outputs information from device 300 (e.g., a display, a speaker, one or more light-emitting diodes (LEDs), etc.).

Communication interface 360 may include a transceiver-like component, such as a transceiver and/or a separate receiver and transmitter, which enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (RF) interface, a universal serial bus (USB) interface, a high-definition multimedia interface (HDMI), or the like.

Device 300 may perform various operations described herein. Device 300 may perform these operations in response to processor 320 executing software instructions included in a computer-readable medium, such as memory 330. A computer-readable medium is defined as a non-transitory memory device. A memory device includes memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided as an example. In practice, device 300 may include additional components, fewer components, different components, or differently arranged components than those shown in FIG. 3. Additionally, or alternatively, one or more components of device 300 may perform one or more functions described as being performed by another one or more components of device 300.

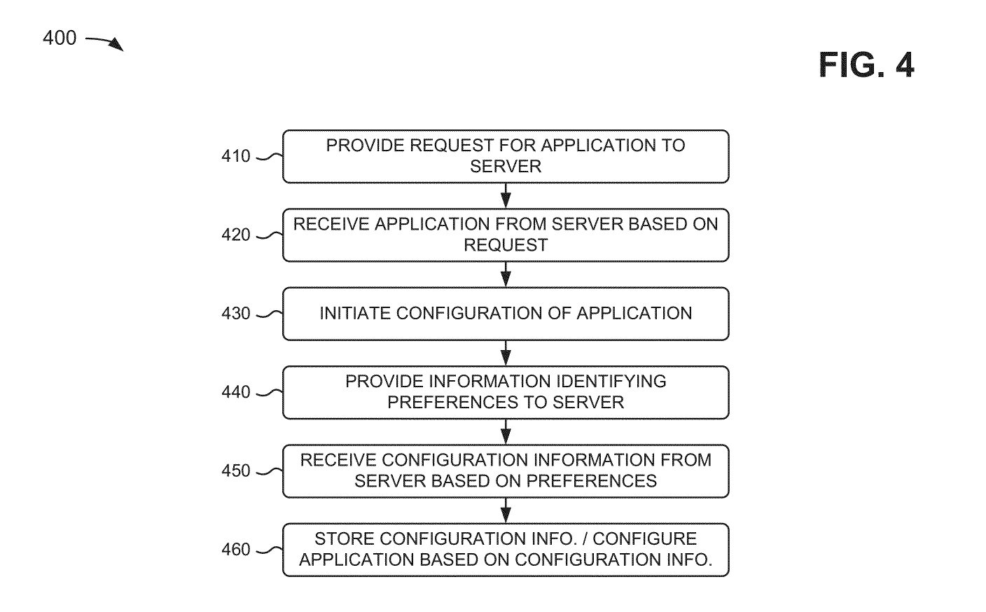

FIG. 4 is a flow chart of an example process 400 for receiving and configuring an application for a user device. In some implementations, one or more process blocks of FIG. 4 may be performed by user device 210. In some implementations, one or more process blocks of FIG. 4 may be performed by another device or a group of devices separate from or including user device 210.

As shown in FIG. 4, process 400 may include providing a request for an application to a server (block 410). For example, a user may cause user device 210 to access a user interface that provides information regarding applications that may be purchased or received free of charge. In some implementations, the user may cause user device 210 to access an application store (e.g., provided by content server 220), which provides information regarding applications that may be purchased or downloaded free of charge. In some implementations, the user may cause user device 210 to access the application store via, for example, a user interface (such as a browser) or in another manner. The user may then select, using user device 210, information regarding a particular application from the information regarding the applications to cause user device 210 to provide a request for the particular application to content server 220.

In some implementations, the particular application may enable a user of user device 210 to quickly and easily locate information associated with products, services, and/or content of an entity based on a captured image associated with the entity. The particular application may also enable the user to quickly retrieve event information (e.g., game information) for the entity based on the captured image.

In some implementations, the user may utilize a camera of user device 210 to capture an image associated with the particular application. For example, if the user purchases a product associated with an entity (e.g., a football jersey), the football jersey may include an image (e.g., a logo of the football team) instructing the user to capture the logo in order to request the particular application. The user may cause user device 210 to capture the logo, which may cause user device 210 to automatically provide a request for the particular application to content server 220.

As further shown in FIG. 4, process 400 may include receiving the application from the server based on the request (block 420). For example, user device 210 may receive the particular application from content server 220, and may store the particular application in a memory associated with user device 210 (e.g., memory 330, FIG. 3). In some implementations, the user, of user device 210, may establish an account associated with the particular application prior to or after receiving the particular application.

As further shown in FIG. 4, process 400 may include initiating a configuration of the application (block 430). For example, the user may initiate the particular application and identify, using user device 210, one or more preferences relating to receiving information associated with products, services, and/or content of an entity based on a captured image of the entity. In some implementations, the user may identify the one or more preferences using one or more elements of a user interface provided by user device 210. The one or more elements may include, for example, one or more text input elements, one or more drop down menu elements, one or more checkbox elements, one or more radio button elements, and/or any other types of elements that may be used to receive information from the user.

In some implementations, the one or more preferences may include a preference of the user with respect to a fight song of the entity, a preference of the user with respect to game footage associated with the entity, a preference of the user with respect to a game image associated with the entity, etc.

In some implementations, the one or more preferences may include a preference of the user with respect to an upcoming event (e.g., a game) associated with the entity, a preference of the user with respect to broadcast information associated with the event, etc.

In some implementations, the one or more preferences may include a preference of the user with respect to providing information associated with products, services, and/or content available at a location of the user based on the captured image, etc.

In some implementations, a type of the account, of the user, associated with the particular application may determine the quantity of preferences that the user is able to identify. For example, the particular application may enable the user to identify only a portion of the above preferences or identify additional preferences based on the type of the account with which the user is associated.

In some implementations, the particular application may analyze information relating to user device 210 and/or the user to determine the one or more preferences of the user and/or to create a profile for the user. For example, the information relating to user device 210 may include browsing history (information relating to the user browsing the Internet), information identifying contacts of the user and/or information identifying communications between the user and the contacts (e.g., e-mail messages, instant messages, and/or the like), documents of the user, information relating to preferences of the user, and/or the like. In some implementations, the particular application may analyze the information relating to user device 210 and/or the user only after receiving an input, from the user, authorizing the analysis. For example, based on the information relating to user device 210 and/or the user, the particular application may identify one or more preferences of the user relating to a particular entity (e.g., a professional baseball team), one or more types of products (e.g., baseball hats for the team, shirts with the team logo, etc.) of interest to the user, one or more genders associated with the products (e.g., women), etc. The particular application may utilize such information to create a profile of the user, with the user's permission.

As further shown in FIG. 4, process 400 may include providing information identifying one or more preferences to the server (block 440). For example, the user may cause user device 210 to provide, to content server 220, information identifying the one or more preferences relating to the user and provided during the configuration of the particular application.

As further shown in FIG. 4, process 400 may include receiving configuration information from the server based on the preferences (block 450). For example, user device 210 may receive, from content server 220, configuration information that may be used to configure the particular application to locate information associated with products, services, and/or content of an entity based on a captured image associated with the entity.

In some implementations, content server 220 may generate the configuration information, which may be used to configure the particular application, based on the information identifying the one or more preferences of the user. For example, the configuration information may include information that identifies one or more entities that provide products, services, and/or content, information that identifies the products, the services, and/or the content, information relating to one or more images of the products, the services, and/or the content, information relating to sounds associated with the products, the services, and/or the content, information relating to video files associated with the products, the services, and/or the content.

In some implementations, the configuration information may include information that identifies one or more sets of instructions to guide a user in capturing (using user device 210 for example) images used to identify the one or more entities. In some implementations, the configuration information may be obtained from a data structure such as, for example, data storage 225. In some implementations, content server 220 may provide, to user device 210, the configuration information independent of receiving the information identifying the one or more preferences of the user.

As further shown in FIG. 4, process 400 may include storing the configuration information and configuring the application based on the configuration information (block 460). For example, the user may cause user device 210 to store all or a portion of the configuration information received from content server 220. The particular application may be configured based on storing all or a portion of the configuration information. In some implementations, the user may configure the particular application by adjusting parameters associated with one or more components of user device 210. For example, the user may adjust light sensitivity for a camera of user device 210, adjust noise cancellation for a microphone of user device 210, etc.

In some implementations, content server 220 may provide updates, to the configuration information, to user device 210 based on use of the particular application by the user. For example, content server 220 may provide updates to the configuration information when the user utilizes the particular application to locate information associated with products, services, and/or content of a particular entity (e.g., a college football team). In another example, content server 220 may receive updates, to the configuration information, from one or more entities and provide the received updates to user device 210. By way of example, a baseball team may provide image information, audio information, video information relating to newly released merchandise associated with the baseball team. User device 210 may store the updates to the configuration information. In some implementations, content server 220 may provide the updates periodically based on a preference of the user and/or based on a time frequency determined by content server 220. In some implementations, content server 220 may determine whether to provide the updates based on the type of the account associated with the particular application.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

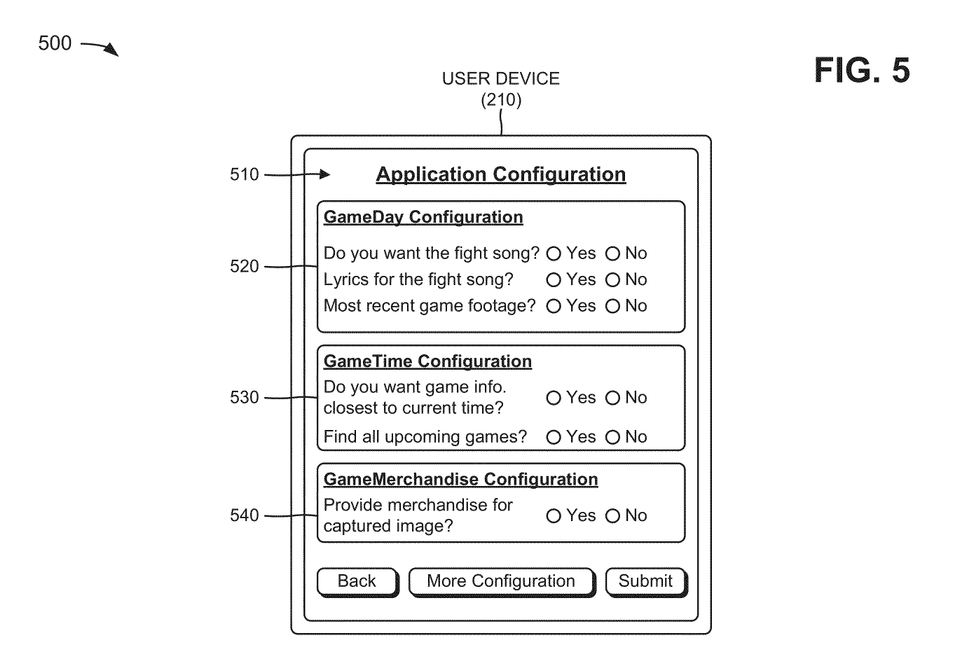

FIG. 5 is diagram of an example user interface 500 that may be used in connection with example process 400 shown in FIG. 4. In some implementations, user interface 500 may be provided by user device 210 to a user, of user device 210, to enable the user to identify information (e.g., preferences) that may be used to configure an application 510 and enable the user to quickly access products, services, and/or content offered by an entity based on an image captured by user device 210.

As shown in relation to FIG. 5, user interface 500 may allow the user to configure different portions of application 510. For example, application 510 may include a GameDay portion that provides content, associated with an entity, to user device 210 based on an image associated with the entity and captured by user device 210. The user may identify preferences for the GameDay portion of application 510 in a configuration section 520. For example, the user may indicate whether the user wants to receive a fight song, lyrics for a fight song, most recent game footage, etc. associated with an entity (e.g., a college sports team) when the user utilizes user device 210 to capture an image associated with the entity.

As further shown in FIG. 5, the application may include a GameTime portion that provides event information, associated with an entity, to user device 210 based on an image associated with the entity and captured by user device 210. The user may identify preferences for the GameTime portion of application 510 in another configuration section 530. For example, the user may indicate whether the user wants to receive game information regarding games occurring closest to a current time, all upcoming games, etc. associated with an entity (e.g., a professional sports team) when the user utilizes user device 210 to capture an image associated with the entity.

As further shown in FIG. 5, the application may include a GameMerchandise portion that provides merchandise information, associated with an entity, to user device 210 based on an image associated with the entity and captured by user device 210. The user may identify preferences for the GameMerchandise portion of application 510 in still another configuration section 540. For example, the user may indicate whether the user wants to receive merchandise information associated with an image captured by user device 210.

In some implementations, the different portions of application 510 may be provided as separate applications by user device 210. In some implementations, the different portions of application 510 may be accessed by the user via a single application, such as application 510. In such implementations, the different portions may be accessed by the user individually via a menu, icons, links, tabs, pages, etc.

Once a user has identified the preferences, user interface 500 may allow the user to select a “Submit” option to store the preferences and/or submit the preferences to content server 220. Content server 220 may then provide, to user device 210, configuration information based on the preferences.

As further shown in FIG. 5, user interface 500 may also allow the user to select a “Back” option to cause user device 210 to provide information regarding the application. As also shown in FIG. 5, user interface 500 may also allow the user to select a “More Configuration” option to enable the user to identify additional information that may be used to configure the application.

The number of elements of user interface 500 shown in FIG. 5 is provided for explanatory purposes. In practice, user interface 500 may include additional elements, fewer elements, different elements, or differently arranged elements than those shown in FIG. 5.

In some implementations, a user interface similar to user interface 500 may be provided to a content provider associated with content server 220, an entity associated with entity server 230, a merchant associated with merchandise server 240, and/or a sponsor associated with sponsorship server 250. The user interface may enable the content provider, the entity, the merchant, and/or the sponsor to configure application 510 for the items (e.g., images, fight songs, game videos, game audio, game images, sponsorships, merchandise, sponsorship, etc.) provided by application 510. In some implementations, the items provided by application 510 may be provided up front or in real-time. If provided in real-time, content server 220 may change the items periodically (e.g., every hour, every day, every week, based on location of user device 210, etc.).

In some implementations, when application is first used by user device 210, the branding, the number of buttons, functionality, etc., may be generic. When the user utilizes user device 210 to capture a first image however, application 510 and the user's profile may begin to be customized. For example, if the first captured image is of a professional football team's logo on a coffee mug, then the branding for application 510 may include be the professional football team, and the buttons and/or functionality may be related to the professional football league. If a user then captures a college team's decal, then the branding may switch to the college team, and the buttons and/or functionality may be related to collegiate sports. In some implementations, the buttons and/or functionality of application 510 may be dynamic depending on a location of the user. For example, if the user is at home using application 510, the buttons and/or functionality may relate checking old game highlights, seeing what time a game is being broadcast, buying merchandise, buying tickets to a next game, etc. If the user is actually at a stadium during a game, application 510 may utilize location functionality to know that the user is located in the stadium, as well as a current time, to relate the buttons and/or functionality to activities inside the stadium, such as pre-game information, real-time highlights of the game, products, and/or the purchase of concessions.

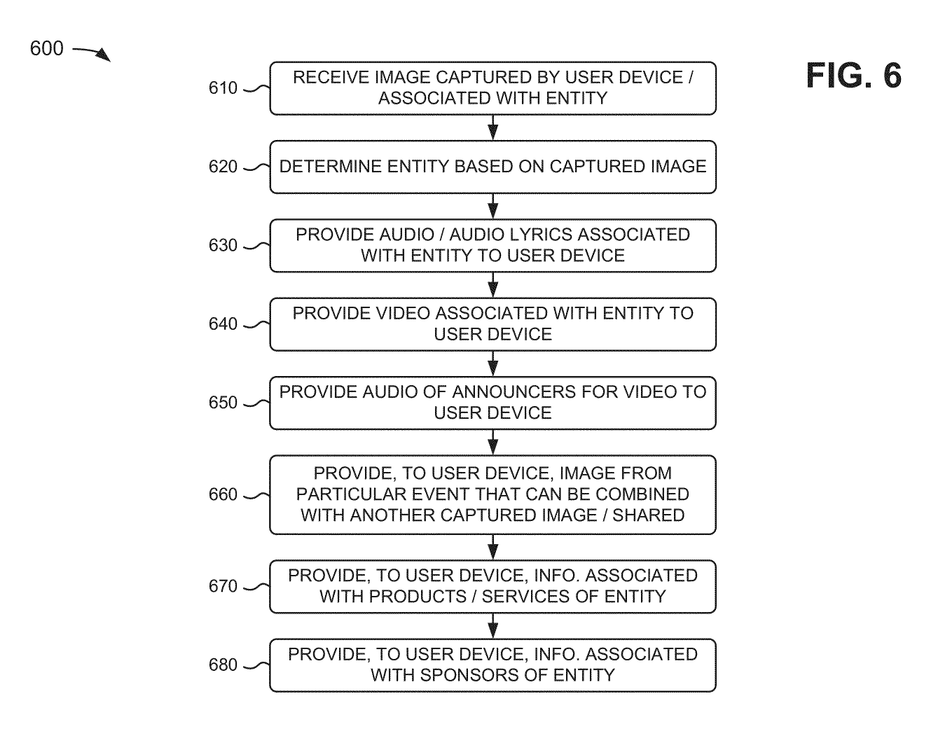

FIG. 6 is a flow chart of an example process 600 for receiving products, services, and/or content associated with an entity based on a captured image. In some implementations, one or more process blocks of FIG. 6 may be performed by content server 220. In some implementations, one or more process blocks of FIG. 6 may be performed by another device or a group of devices separate from or including content server 220.

As shown in FIG. 6, process 600 may include receiving an image captured by a user device and associated with an entity (block 610). For example, a user may utilize user device 210 to access the GameDay portion of application 510, and the GameDay portion may instruct the user to capture an image with a camera of user device 210. In some implementations, based on the instruction, the user may utilize the camera of user device 210 to capture an image associated with an entity. For example, user device 210 may capture an image associated with a college sports team, such as a team logo provided on a hat. After the image is captured, the GameDay portion may cause user device 210 to provide the captured image to content server 220. Content server 220 may receive the captured image (e.g., the image of the team logo) from user device 210.

As further shown in FIG. 6, process 600 may include determining the entity based on the captured image (block 620). For example, content server 220 may determine the entity (e.g., the college sports team) based on the captured image (e.g., of the team logo). In some implementations, data storage 225 may include images associated with entities, such as team logos, images of mascots, images of team players, images of stadiums, etc.; names associated with entities, such as team names, team nicknames, school names, etc.; and other entity information. If the captured image includes an image associated with an entity (e.g., a team logo, an image of a mascot, etc.), content server 220 may compare the captured image with the images provided in data storage 225 in order to identify an entity associated with the captured image. In some implementations, content server 220 may perform image recognition of the captured image when comparing the captured image with the images provided in data storage 225. If the captured image matches a particular image in data storage 225, content server 220 may determine the entity associated with the particular image.

In some implementations, if the captured image includes a name associated with an entity (e.g., a school name), content server 220 may perform character recognition of the captured image in order to determine the name provided in the captured image. Content server 220 may compare the determined name with the names provided in data storage 225 in order to identify an entity associated with the captured image. For example, if the determined name matches the name of a college sports team provided in data storage 225, content server 220 may determine that the entity associated with the captured image is the college sports team.

As further shown in FIG. 6, process 600 may include providing audio and/or audio lyrics associated with the entity to the user device (block 630). For example, based on determining the entity associated with the captured image, content server 220 may retrieve audio and/or audio lyrics associated with the entity, and may provide the audio and/or the audio lyrics to user device 210. In some implementations, data storage 225 may include content (e.g., images, videos, audio files, etc.) associated with entities; information associated with products of entities; information associated with services of entities; information associated with sponsors of entities; etc. In some implementations, content server 220 may retrieve the audio and/or the audio lyrics associated with the entity from data storage 225.

In some implementations, user device 210 may receive the audio and/or the audio lyrics, and may play the audio for the user and/or display the audio lyrics to the user. In some implementations, if the entity is a college sports team, the audio may include a fight song associated with the college sports team and the audio lyrics may include the lyrics of the fight song. If the entity is a singer, the audio may include a most popular song of the singer and the audio lyrics may include the lyrics of the song. If the entity is a company, the audio may include audio of a commercial for products of the company, and the audio lyrics may include the words used in the commercial.

As further shown in FIG. 6, process 600 may include providing a video associated with the entity to the user device (block 640). For example, based on determining the entity associated with the captured image, content server 220 may retrieve (e.g., from data storage 225) a video associated with the entity, and may provide the video to user device 210. In some implementations, user device 210 may receive the video, and may play the video for the user. In some implementations, if the entity is a college football team, the video may include game footage of a recent game played by the college football team. For example, the game footage may include footage of touchdowns scored by the college football team in the recent game. In some implementations, if the entity is a rock band, the video may include a portion of a new music video of the rock band. If the entity is a company, the video include a new commercial for services offered by the company.

As further shown in FIG. 6, process 600 may include providing audio of announcers for the video to the user device (block 650). For example, content server 220 may retrieve (e.g., from data storage 225) audio of announcers for the video, and may provide the audio to user device 210. In some implementations, user device 210 may receive the audio of the announcers, and may play the audio of the announcers for the user. For example, if the entity is a college football team, the audio may include audio of announcers affiliated with the college football team, and a play-by-play of game footage of a recent game played by the college football team. In some implementations, the audio may include audio of announcers affiliated with the college football team's opponent, and a play-by-play of game footage of a recent game played against the opponent. In some implementations, the audio may include audio of announcers associated with a broadcast television network televising the recent game played by the college football team. In some implementations, if the entity is not a sports team, content server 220 may not retrieve audio of announcers for the video, and may not provide such audio to user device 210.

As further shown in FIG. 6, process 600 may include providing, to the user device, an image from a particular event, associated with the entity, that may be combined with another captured image and/or shared (block 660). For example, based on determining the entity associated with the captured image, content server 220 may retrieve (e.g., from data storage 225) an image from a particular event associated with the entity, and may provide the image to user device 210. In some implementations, user device 210 may receive the image, and may display the received image to the user. In some implementations, the received image may include an open portion that may be used to view subjects and/or objects with the camera of user device 210. The user may utilize the open portion of the received image to view a subject (e.g., a friend) with the camera and to capture another image. The GameDay portion of the application may cause user device 210 to combine the captured other image with the received image, and to display the combined images to the user. In some implementations, the GameDay portion may enable the user to share the combined images with other user devices 210 via an email, social media, a text message, etc.

For example, if the entity is a professional baseball team, the received image may include an image from a final game of a World Series won by the team. The received image may include a player of the team holding up the World Series trophy, and may include an open portion adjacent to the player. The user may utilize the camera of user device 210 and the open portion of the received image to view the user's friend, and to capture an image of the user's friend. The GameDay portion may combine the image of the friend with the received image of the player holding up the World Series trophy. In some implementations, the images may be combined so that it appears as if the friend is at the World Series and next to the player. The user may utilize user device 210 to store the combined images (e.g., in memory 330, FIG. 3), to post the combined images on a social media web site, to email the combined images (e.g., to the friend), to send the combined images (e.g., to the friend) via a text message, etc.

As further shown in FIG. 6, process 600 may include providing, to the user device, information associated with products and/or services of the entity (block 670). For example, based on determining the entity associated with the captured image, content server 220 may retrieve (e.g., from data storage 225) information associated with products and/or services of the entity, and may provide the information associated with the products and/or the services to user device 210. In some implementations, user device 210 may receive the information associated with the products and/or the services, and may display the information associated with the products and/or the services to the user. In some implementations, content server 220 may provide, to user device 210, the information associated with the products and/or the services of the entity along with the audio, the audio lyrics, the video, the audio of announcers for the video, etc. associated with the entity.

In some implementations, if the entity is a professional lacrosse team, the information associated with the products and/or the services may include information about tickets for an upcoming game of the team; information about jerseys, hats, bumper stickers, etc. with the team's name and/or logo that are available for purchase; information about players on the team (e.g., whether a player is injured); information about the team's schedule; etc.

In some implementations, if the entity is a movie star, the information associated with the products and/or the services may include information about tickets for an upcoming movie with the movie star; video clips of trailers for movies with the movie star; images of the movie star, information about shirts, hats, and other merchandise with the movie star's image; biographical information of the movie star, information about television appearances of the movie star, etc.

As further shown in FIG. 6, process 600 may include providing, to the user device, information associated with sponsors of the entity (block 680). For example, based on determining the entity associated with the captured image, content server 220 may retrieve (e.g., from data storage 225) information associated with sponsors of the entity, and may provide the information associated with the sponsors to user device 210. In some implementations, user device 210 may receive the information associated with the sponsors, and may display the information associated with the sponsors to the user. In some implementations, content server 220 may provide, to user device 210, the information associated with the sponsors of the entity along with the audio, the audio lyrics, the video, the audio of announcers for the video, etc. associated with the entity.

In some implementations, the information associated with the sponsors of the entity may include advertisements of the sponsors, information associated with products, services, and/or content offered by the sponsors, etc. For example, if the entity is a university, a sponsor of the university may include a local restaurant of the university. In such an example, the information associated with the local restaurant may include an advertisement for the local restaurant, special offers for university students at the local restaurant, a menu for the local restaurant, etc.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

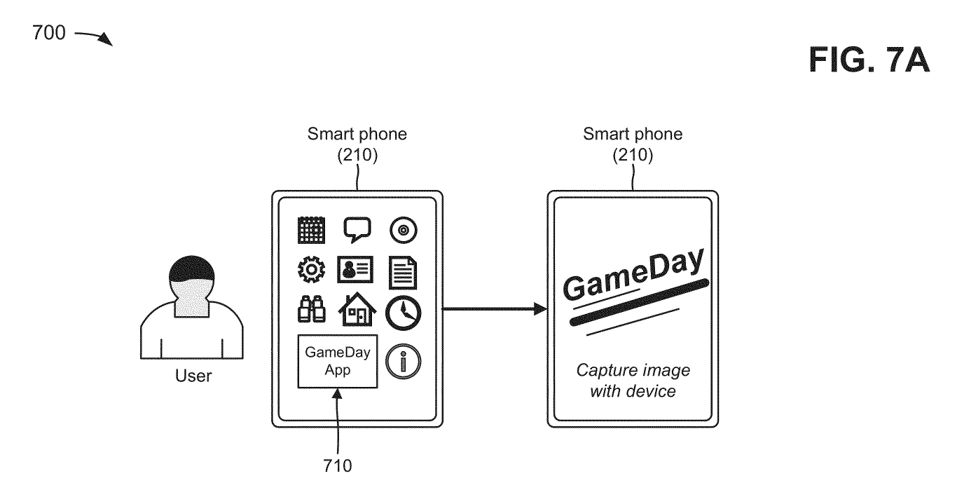

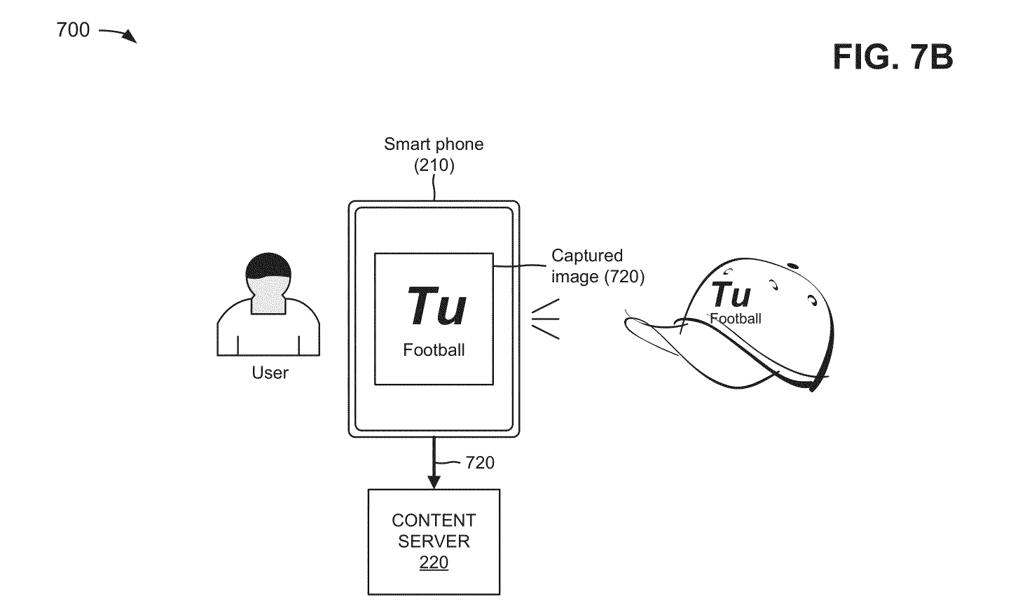

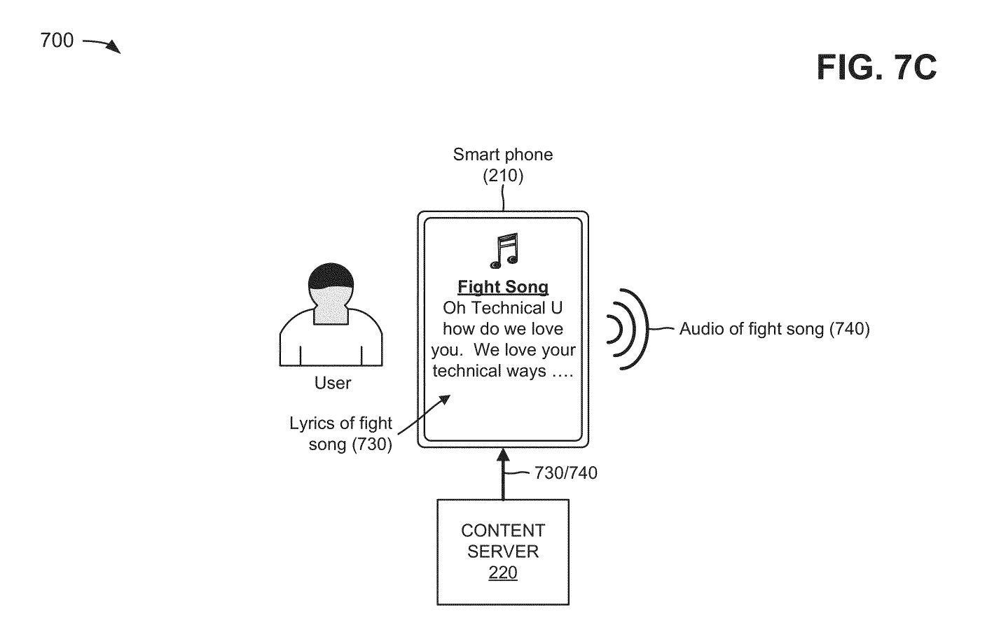

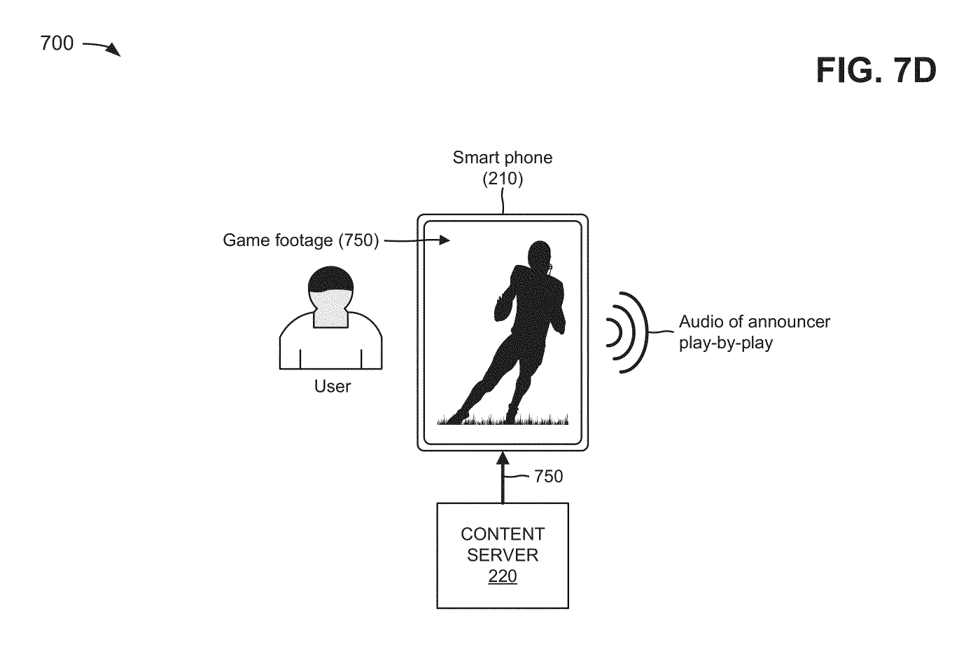

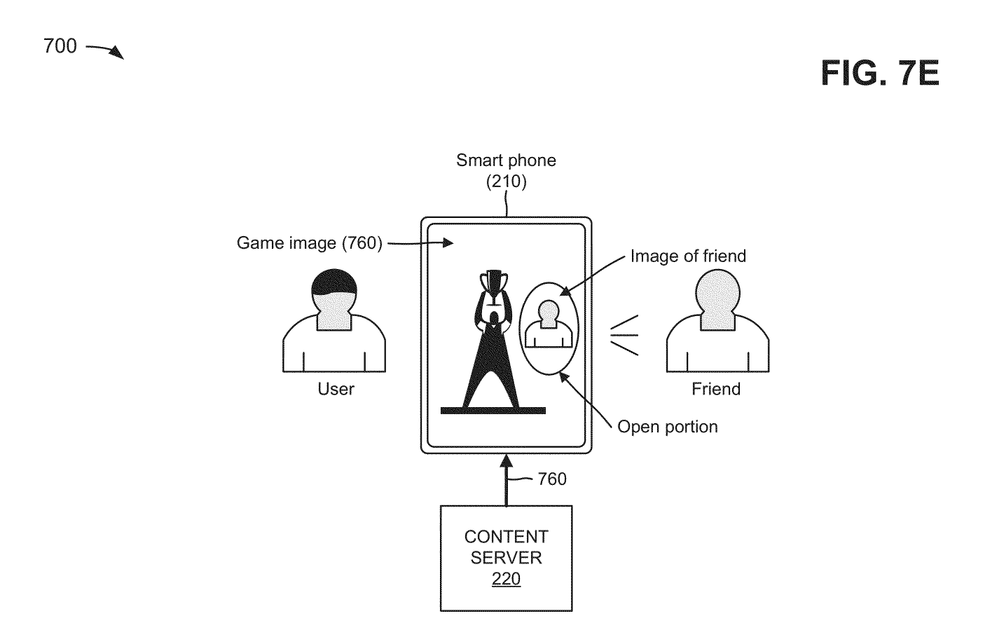

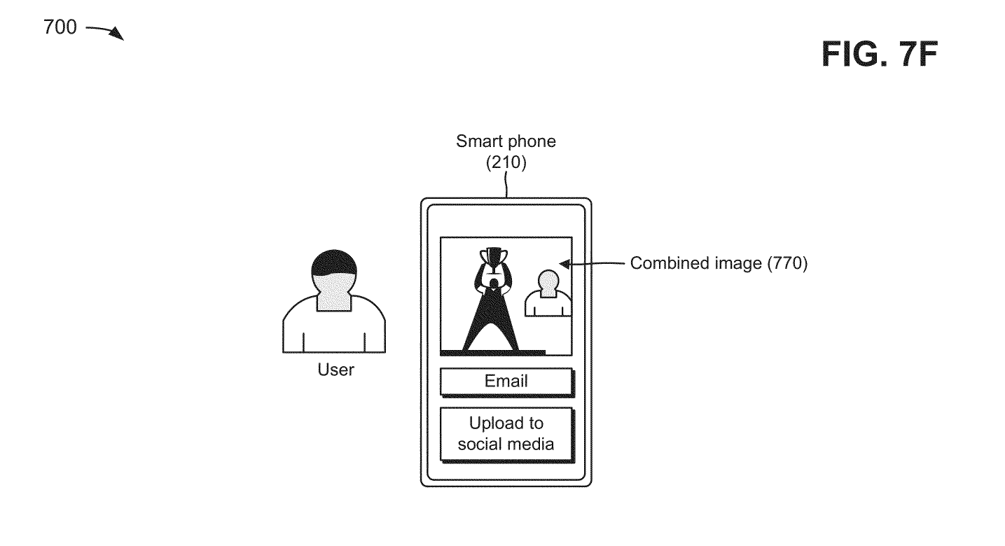

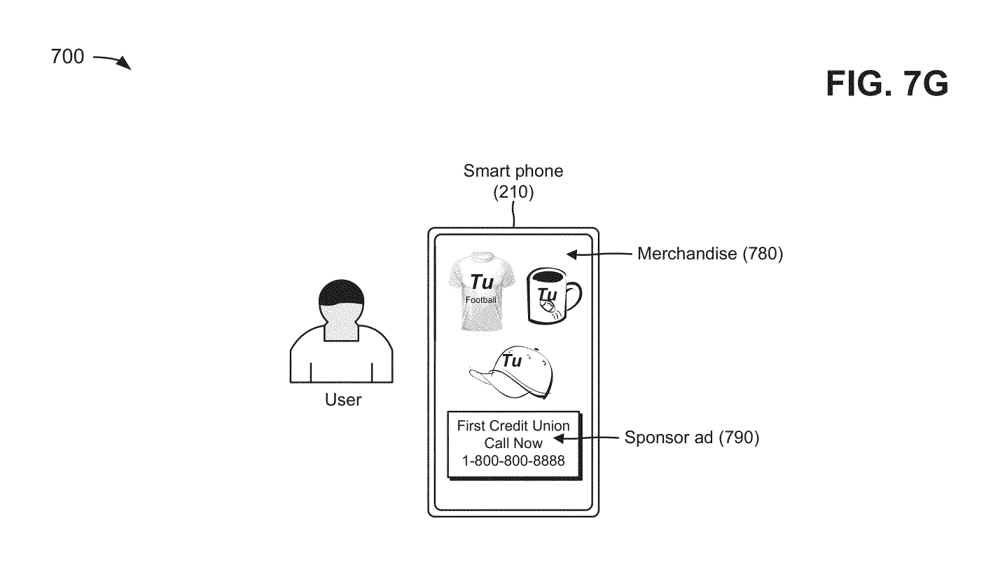

FIGS. 7A-7G are diagrams of an example 700 relating to example process 600 shown in FIG. 6. In example 700, assume that a user is associated with user device 210 (e.g., a smart phone 210), as shown in FIG. 7A. Further, assume that that user utilizes smart phone 210 to select a GameDay application (app) 710 (e.g., the GameDay portion of application 510, FIG. 5) stored in smart phone 210. When the user selects GameDay application 710, application 710 may cause smart phone 210 to display a home page for GameDay application 710. As further shown in FIG. 7A, the home page may instruct the user to capture an image with smart phone 210 (e.g., with a camera of smart phone 210).

As shown in FIG. 7B, the user may utilize the camera of smart phone 210 to view and capture a TU football logo provided on a baseball hat. Smart phone 210 may display a captured image 720 of the TU football logo to the user, as further shown in FIG. 7B. GameDay application 710 may cause smart phone 210 to provide captured image 720 to content server 220, and content server 220 may receive captured image 720. Assume that content server 220 determines that captured image 720 is associated with a particular entity (e.g., the TU football team) by performing character recognition of captured image 720 and/or by comparing captured image 720 with images provided in data storage 225.

In some implementations, and based on the determination of the entity, content server 220 may retrieve (e.g., from data storage 225) lyrics 730 of a fight song for the TU football team and an audio file 740 of the fight song, as shown in FIG. 7C. Content server 220 may provide lyrics 730 of the fight song and audio file 740 of the fight song to smart phone 210, and smart phone 210 may store lyrics 730 of the fight song and/or audio file 740 of the fight song. Smart phone 210 may display lyrics 730 of the fight song (e.g., “Oh Technical U how do we love you. We love your technical ways . . . . ”) to the user and/or may play audio file 740 of the fight song for the user, as further shown in FIG. 7C.

In some implementations, and based on the determination of the entity, content server 220 may retrieve (e.g., from data storage 225) a video 750 of game footage from a recent game for the TU football team, as shown in FIG. 7D. Content server 220 may provide video 750 of the game footage to smart phone 210, and smart phone 210 may store video 750 of the game footage. In some implementations, content server 220 may provide an audio file of an announcer (e.g., an announcer for the TU football team or for an opponent of the TU football team) for the game footage to smart phone 210, and smart phone 210 may store the audio file of the announcer for the game footage. As further shown in FIG. 7D, smart phone 210 may play video 750 of the game footage for the user and/or may play the audio file of the announcer for the user.

In some implementations, and based on the determination of the entity, content server 220 may retrieve (e.g., from data storage 225) a game image 760 from a famous game for the TU football team (e.g., a national championship game), as shown in FIG. 7E. In some implementations, content server 220 may alter game image 760 so that game image 760 includes an open portion (e.g., a portion that is cropped and removed) through which the camera of smart phone 210 may view a subject and/or an object. Content server 220 may provide the altered game image 760 to smart phone 210, and smart phone 210 may store the altered game image 760. As further shown in FIG. 7E, smart phone 210 may display game image 760 with the open portion to the user. Assume that the user utilizes game image 760 and the camera of smart phone 210 to view a friend of the user, and to capture an image of the friend within the open portion of game image 760.

After the camera of smart phone 210 captures the image of the friend within the open portion of game image 760, GameDay application 710 may combine the image of the friend with game image 760 to create a combined image 770, as shown in FIG. 7F. In some implementations, combined image 770 may be arranged so that it appears as if the friend is at the game associated with game image 760. Smart phone 210 may store combine image 770. In some implementations, GameDay application 710 may enable the user to share combined image 770 with other users via email, a social media account of the user, a text message, an instant message, etc., as further shown in FIG. 7F. For example, the user may provide combined image 770 to a user device 210 associated with the friend via a text messaging application provided in smart phone 210.

In some implementations, and based on the determination of the entity, content server 220 may retrieve (e.g., from data storage 225) information 780 associated with merchandise (e.g., hats, mugs, T-shirts, etc.) of the TU football team and an advertisement 790 from a sponsor of the TU football team, as shown in FIG. 7G. Content server 220 may provide merchandise information 780 and sponsor advertisement 790 to smart phone 210, and smart phone 210 may store merchandise information 780 and sponsor advertisement 790. As further shown in FIG. 7G, smart phone 210 may display merchandise information 780 and/or sponsor advertisement 790 to the user. The user may utilize smart phone 210 to select an item (e.g., a hat) from merchandise information 780, and to purchase the hat. The user may also utilize smart phone 210 to select sponsor advertisement 790 so that additional information associated with the sponsor (e.g., a web site of the sponsor) may be displayed to the user. Is some implementations, the sponsor could offer a coupon or a discount on merchandise if the user selects sponsor advertisement 790.

As indicated above, FIGS. 7A-7G are provided merely as an example. Other examples are possible and may differ from what was described with regard to FIGS. 7A-7G. In some implementations, the various operations described in connection with FIGS. 7A-7G may be performed automatically or at the request of the user.

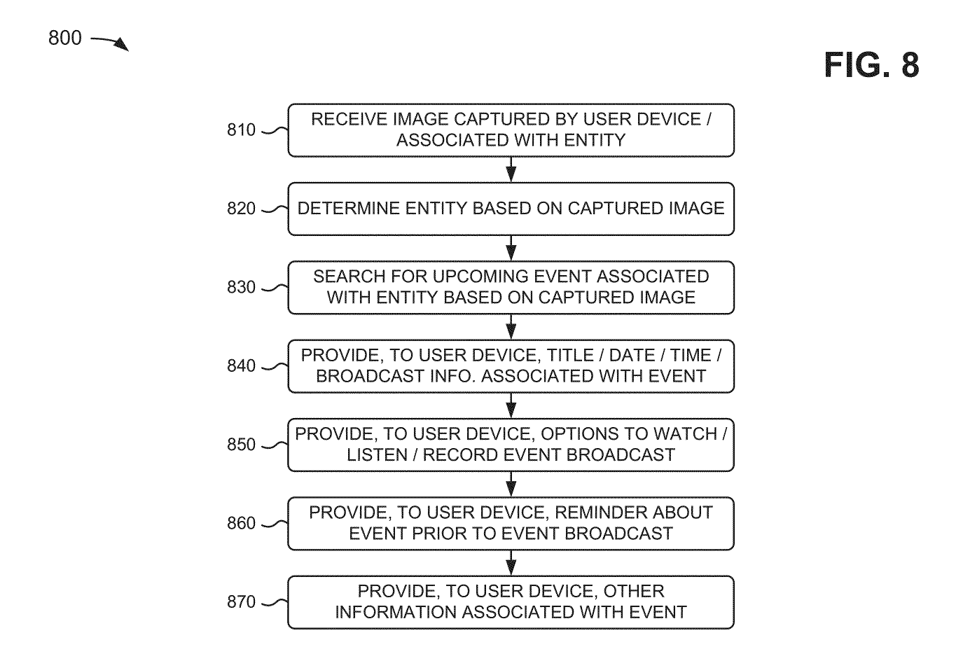

FIG. 8 is a flow chart of an example process 800 for receiving event information associated with an entity based on a captured image. In some implementations, one or more process blocks of FIG. 8 may be performed by content server 220. In some implementations, one or more process blocks of FIG. 8 may be performed by another device or a group of devices separate from or including content server 220.

As shown in FIG. 8, process 800 may include receiving an image captured by a user device and associated with an entity (block 810). For example, a user may utilize user device 210 to access the GameTime portion of application 510 (FIG. 5), and the GameTime portion may instruct the user to capture an image with a camera of user device 210. In some implementations, based on the instruction, the user may utilize the camera of user device 210 to capture an image associated with an entity. For example, user device 210 may capture an image associated with a professional sports team, such as a team logo provided on a shirt. After the image is captured, the GameTime portion may cause user device 210 to provide the captured image to content server 220. Content server 220 may receive the captured image (e.g., the image of the team logo) from user device 210.

As further shown in FIG. 8, process 800 may include determining the entity based on the captured image (block 820). For example, content server 220 may determine the entity (e.g., the professional sports team) based on the captured image (e.g., of the team logo). In some implementations, if the captured image includes an image associated with an entity (e.g., a team logo, an image of a mascot, etc.), content server 220 may compare the captured image with the images provided in data storage 225 in order to identify an entity associated with the captured image. In some implementations, content server 220 may perform image recognition of the captured image when comparing the captured image with the images provided in data storage 225. If the captured image matches a particular image in data storage 225, content server 220 may determine the entity associated with the particular image.

In some implementations, if the captured image includes a name associated with an entity (e.g., a team name), content server 220 may perform character recognition of the captured image in order to determine the name provided in the captured image. Content server 220 may compare the determined name with the names provided in data storage 225 in order to identify an entity associated with the captured image. For example, if the determined name matches the name of a professional sports team provided in data storage 225, content server 220 may determine that the entity associated with the captured image is the professional sports team.

As further shown in FIG. 8, process 800 may include searching for an upcoming event associated with the entity based on the captured image (block 830). For example, content server 220 may search for an upcoming event (e.g., an upcoming game) associated with the entity (e.g., the professional sports team) based on the captured image. In some implementations, data storage 225 may include information associated with upcoming events of entities, such as games, shows, performances, television appearances, etc. associated with entities. The information associated with the upcoming events may include titles of the events, dates and times associated with the events, broadcast information (e.g., a network or channel broadcasting the event) of the events, etc. In some implementations, content server 220 may retrieve information associated with upcoming events of the entity (e.g., the professional sports team) from data storage 225, and may determine an upcoming event with a date that is closest to a current date based on the retrieved information. For example, if the professional sports team has games on December 1st, 7th, and 14th, content server 220 may determine that the game on December 1st is the closest to the current date.

In some implementations, if the entity is a singer, the information associated with upcoming events of the singer may include dates, times, and locations associated with performances of the singer. In such implementations, content server 220 may determine an upcoming event of the singer with a location that is closest to a location of the user and/or with a date that is closest to a current date. For example, if the user is located in Dallas and the singer is performing a show in Austin on December 1st, a show in Dallas on December 3rd, and a show in Los Angeles on December 7th, content server 220 may determine that the show in Dallas is the closest to the user.

As further shown in FIG. 8, process 800 may include providing, to the user device, title, date, time, and/or broadcast information associated with the upcoming event (block 840). For example, content server 220 may retrieve (e.g., from data storage 225) information associated with the upcoming event of the entity. In some implementations, if the entity is a professional sports team, the upcoming event may include an upcoming game to be played by the professional sports team. In such implementations, the information associated with the upcoming event may include a title of the upcoming game (e.g., a Professional Team 1 versus Professional Team 2 football game), a date of the upcoming game (e.g., Dec. 1, 2013), a time of the upcoming game (e.g., 1:00-4:00 PM), broadcast information for the upcoming game (e.g., on the TU network or channel 333), etc. In some implementations, content server 220 may provide the information associated with the upcoming event to user device 210, and user device 210 may display the information associated with the upcoming event to the user.

In some implementations, if the entity is a television actor, the upcoming event may include an upcoming television show starring the actor. In such implementations, the information associated with the upcoming event may include a title of the television show (e.g., Computer Meltdown), a date of the television shown (e.g., Dec. 30, 2013), a time of the television show (e.g., 10:00-11:00 PM), broadcast information for the television show (e.g., The Tech Network or channel 899), etc.

As further shown in FIG. 8, process 800 may include providing, to the user device, options to watch, listen to, and/or record a broadcast of the upcoming event (block 850). For example, content server 220 may provide, to user device 210 and via the GameTime portion, an option to watch a broadcast of the upcoming event, an option to listen to a radio broadcast of the upcoming event, and/or an option to record the broadcast of the upcoming event. In some implementations, user device 210 may receive the options, and may display the options to the user. In some implementations, if the entity is a college sports team (e.g., the TU football team), content server 220 may provide, to user device 210, an option to watch a television broadcast of an upcoming TU football game (e.g., via user device 210), an option to listen to a radio broadcast of the upcoming TU football game (e.g., via user device 210), and/or an option to record the television and/or the radio broadcasts of the upcoming TU football game on user device 210.

In some implementations, if the entity is a band, content server 220 may provide, to user device 210, an option to watch a television broadcast of an upcoming concert for the band (e.g., via user device 210), an option to listen to a radio broadcast of the upcoming concert for the band, and/or an option to record the television and/or the radio broadcasts of the upcoming concert for the band on user device 210.

As further shown in FIG. 8, process 800 may include providing, to the user device, a reminder about the upcoming event prior to the event broadcast (block 860). For example, content server 220 may provide, to user device 210 and via the GameTime portion, an option to set a reminder for the upcoming event prior to the broadcast of the upcoming event. In some implementations, user device 210 may receive the option to set the reminder, and may display the option to set the reminder to the user. The user may utilize user device 210 to specify when the reminder should be provided to user device 210 (e.g., one, two, three, etc. minutes, hours, days, etc.) prior to the broadcast of the upcoming event. In some implementations, the reminder may include a visual reminder displayed by user device 210 (e.g., indicating that the upcoming event will be broadcast soon), an audio reminder played by user device 210 (e.g., a voice stating that the upcoming event will be broadcast soon), or a visual and an audio reminder displayed and played by user device 210.

For example, assume that the user wants to be reminded about an upcoming baseball game for a favorite team (e.g., the entity) thirty minutes prior to the baseball game start time. The user may utilize user device 210 to select the option for the reminder and to indicate that the reminder should be provided thirty minutes prior to the start time of the baseball game. If the baseball game starts at 12:45 PM, user device 210 may display a visual reminder (e.g., “The game will start in 30 minutes”), may play an audio reminder (e.g., an alarm sound, a voice indicating that “The game will start in 30 minutes,” etc.), may cause user device 210 to vibrate, etc. at 12:15 PM. In some implementations, the reminder may be provided by content server 220 to user device 210. In some implementations, the reminder may be generated directly by user device 210 (e.g., by the GameTime portion of application 510).

As further shown in FIG. 8, process 800 may include providing, to the user, other information associated with the upcoming event (block 870). For example, content server 220 may retrieve (e.g., from data storage 225) other information associated with the upcoming event of the entity. In some implementations, if the entity is a college football team, the other information associated with the upcoming event may include weather information for the upcoming game (e.g., sunny and 75° F.), ticket availability for the upcoming game, information about injuries to players for the college football team, gambling information about the upcoming game (e.g., a point spread, odds of the college football team winning, etc.), etc. In some implementations, content server 220 may provide the other information associated with the upcoming event to user device 210, and user device 210 may display the other information associated with the upcoming event to the user.

In some implementations, user device 210 may display the title, date, time, and/or broadcast information for the upcoming event, the options to watch, listen to, and record the upcoming event broadcast, the option to set the reminder, and the other information associated with the upcoming event via a single user interface or via multiple user interfaces.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

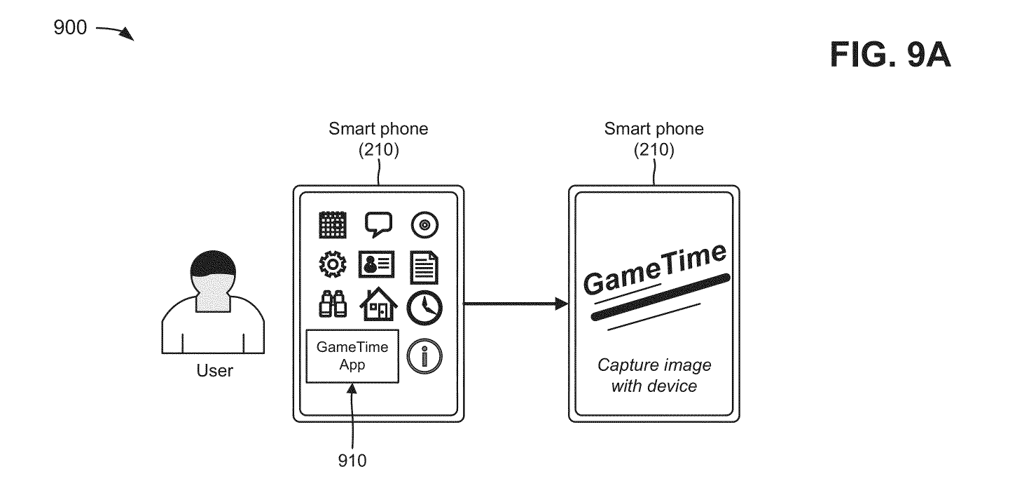

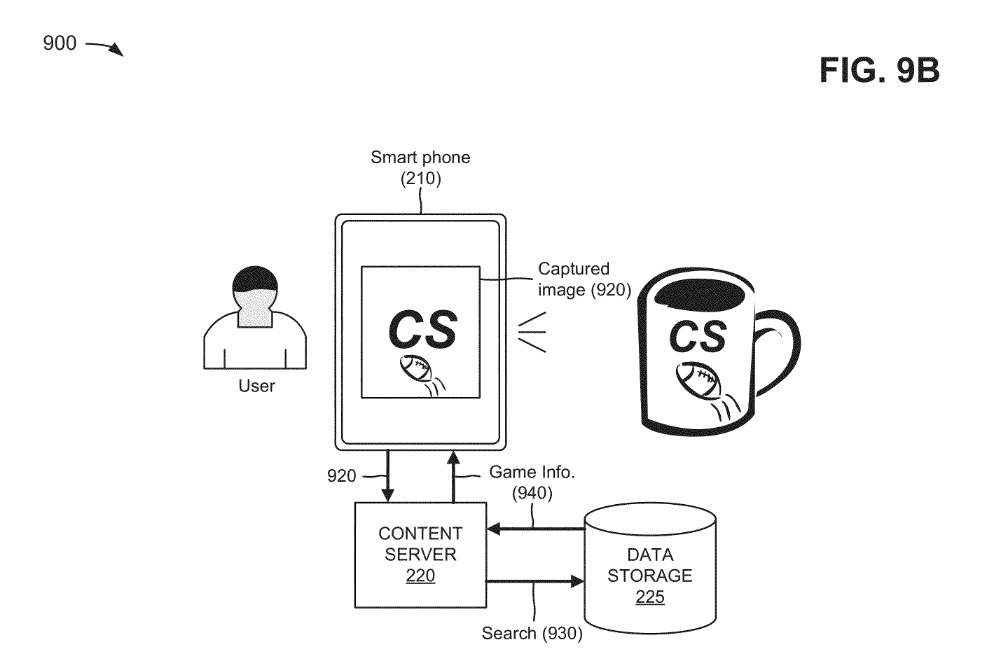

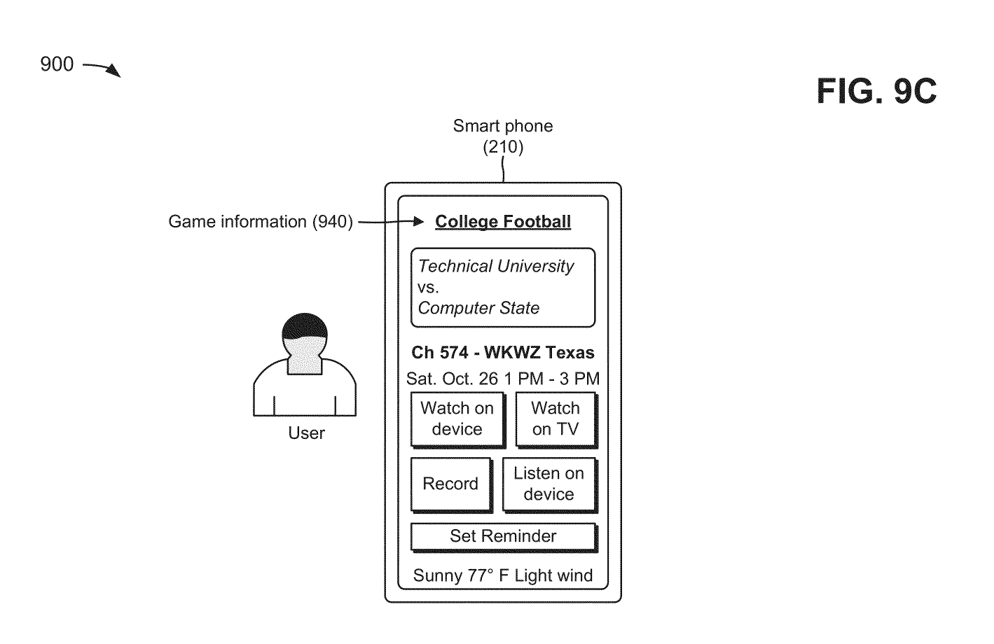

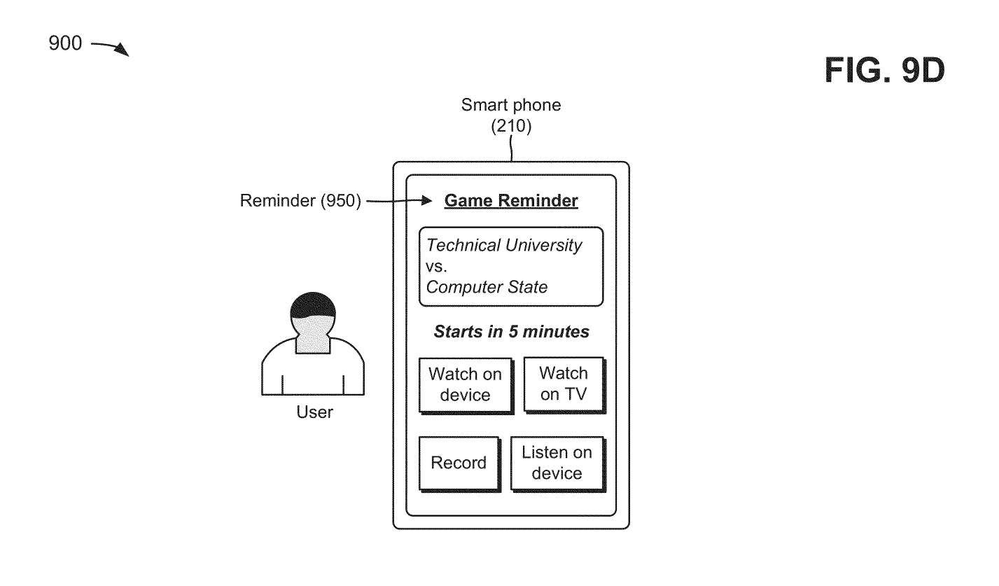

FIGS. 9A-9D are diagrams of an example 900 relating to example process 800 shown in FIG. 8. In example 900, assume that a user is associated with user device 210 (e.g., a smart phone 210), as shown in FIG. 9A. Further, assume that the user utilizes smart phone 210 to select a GameTime application (app) 910 (e.g., the GameTime portion of application 510, FIG. 5) stored in smart phone 210. When the user selects GameTime application 910, application 910 may cause smart phone 210 to display a home page for GameTime application 910. As further shown in FIG. 9A, the home page may instruct the user to capture an image with smart phone 210 (e.g., with a camera of smart phone 210).

As shown in FIG. 9B, the user may utilize the camera of smart phone 210 to view and capture a Computer State (CS) football logo provided on a coffee mug. Smart phone 210 may display a captured image 920 of the CS football logo to the user, as further shown in FIG. 9B. GameTime application 910 may cause smart phone 210 to provide captured image 920 to content server 220, and content server 220 may receive captured image 920. Assume that content server 220 determines that captured image 920 is associated with a particular entity (e.g., the CS football team) by performing character recognition of captured image 920 and/or by comparing captured image 920 with images provided in data storage 225. Once content server 220 determines the entity (e.g., the CS football team) associated with captured image 920, content server 220 may perform a search 930 of data storage 225 for an upcoming game to be played by the CS football team, as further shown in FIG. 9B. Based on search 930, data storage 225 may return game information 940 associated with the upcoming game to content server 220, and content server 220 may provide game information 940 to smart phone 210.

Smart phone 210 may receive game information 940, and may store game information 940. Smart phone 210 may display some or all of game information 940 to the user, as shown in FIG. 9C. For example, smart phone 210 may display, to the user, a title of the upcoming game (e.g., College Football—Technical University vs. Computer State); broadcast information for the upcoming game (e.g., the game will be broadcast on Channel 574 by WKWZ Texas); a date and time of the upcoming game (e.g., Oct. 26, 2013 from 1:00-3:00 PM); an option to watch the upcoming game on smart phone 210 (e.g., “Watch on device”); an option to watch the upcoming game on television (e.g., “Watch on TV”); an option to record the upcoming game on smart phone 210 (e.g., “Record”), in the cloud, on a home digital video recorder (DVR), etc; an option to listen to the upcoming game on smart phone 210 (e.g., “Listen on device”); an option to set a reminder about the upcoming game (e.g., “Set Reminder”); and other information about the upcoming game (e.g., weather conditions for the game).

In some implementations, if the user selects the watch on device option, smart phone 210 may play a video broadcast of the game on smart phone 210 if the game is beginning or has begun. If the game has not begun, smart phone 210 may provide an indication to the user that game has not begun, and may play (or ask the user for permission to play) the broadcast of the game when the game begins. In some implementations, if the user selects the watch on television option, smart phone 210 may automatically set a reminder for the user prior to the broadcast of the upcoming game.

In some implementations, if the user selects the record option, smart phone 210, the cloud, the home DVR, etc. may record the broadcast of the game whether the user is watching or listening to the game via smart phone 210, or may record the broadcast of the game only when the user is watching or listening to the game via smart phone 210. In some implementations, if the user selects the listen on device option, smart phone 210 may play a radio broadcast of the game on smart phone 210 if the game is beginning or has begun. If the game has not begun, smart phone 210 may provide an indication to the user that game has not begun, and may play (or ask the user for permission to play) the radio broadcast of the game when the game begins. In some implementations, the user may be provided a choice of which team's radio broadcast to receive. For example, the user may start by listening to his favorite team's radio broadcast when a big play occurs since the user may enjoy hearing the excitement in broadcasters' voices. However, the user may switch over to hear the radio broadcast of the other team, since the user may enjoy hearing the gloom of a radio broadcast for the opposing team.

In some implementations, if the user selects the set reminder option, the user may specify parameters for a reminder about the game (e.g., when to receive the reminder, how to receive the reminder (e.g., visually and/or audibly), etc.). For example, assume that the user indicates that the reminder should be displayed to the user five minutes before the game starts. Smart phone 210 may store the parameters for the reminder and/or may provide the parameters to content server 220. In this example, when it is five minutes before the game starts (e.g., at 12:55 PM on Oct. 26, 2013), smart phone 210 may receive a reminder 950 from content server 220 or may retrieve reminder 950 from memory, and may display reminder 950 to the user, as shown in FIG. 9D. As shown, reminder 950 may indicate that the game between Technical University and Computer State is about to start in five minutes. Reminder 950 may also display the option to watch the game on smart phone 210, the option to watch the game on television, the option to record the game, and the option to listen to the game on smart phone 210, as further shown in FIG. 9D.

As indicated above, FIGS. 9A-9D are provided merely as an example. Other examples are possible and may differ from what was described with regard to FIGS. 9A-9D. In some implementations, the various operations described in connection with FIGS. 9A-9D may be performed automatically or at the request of the user.

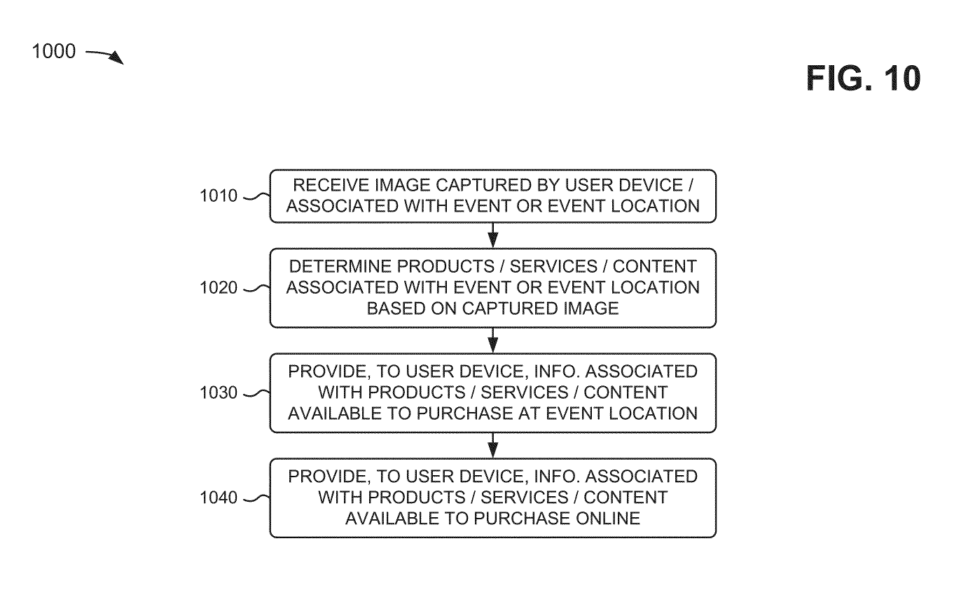

FIG. 10 is a flow chart of an example process 1000 for receiving products, services, and/or content associated with an event and/or an event location based on a captured image. In some implementations, one or more process blocks of FIG. 10 may be performed by content server 220. In some implementations, one or more process blocks of FIG. 10 may be performed by another device or a group of devices separate from or including content server 220.

As shown in FIG. 10, process 1000 may include receiving an image captured by a user device and associated with an event or an event location (block 1010). For example, a user may utilize user device 210 to access the GameMerchandise portion of application 510 (FIG. 5), and the GameMerchandise portion may instruct the user to capture an image with a camera of user device 210. In some implementations, based on the instruction, the user may utilize the camera of user device 210 to capture an image associated with an event or an event location. For example, user device 210 may capture an image associated with a sporting event (e.g., a game), a concert, a performance, a stadium, a concert hall, a scoreboard, etc. After the image is captured, the GameMerchandise portion may cause user device 210 to provide the captured image to content server 220. Content server 220 may receive the captured image (e.g., an image of a scoreboard at a stadium) from user device 210.

As further shown in FIG. 10, process 1000 may include determining products, services, and/or content associated with the event or the event location based on the captured image (block 1020). For example, content server 220 may determine the event (e.g., a championship football game) or the event location (e.g., a stadium where the championship football game is being played) based on the captured image (e.g., an image of a scoreboard at the stadium). In some implementations, if the captured image includes an image associated with an event (e.g., an event logo, an image of a mascot of a team playing in a game, etc.) or an event location (e.g., a scoreboard, a structure in a stadium, a logo on a field of the stadium, etc), content server 220 may compare the captured image with the images provided in data storage 225 in order to identify an event or an event location associated with the captured image. In some implementations, content server 220 may perform image recognition of the captured image when comparing the captured image with the images provided in data storage 225. If the captured image matches a particular image in data storage 225, content server 220 may determine the event or the event location associated with the particular image. In some implementations, content server 220 may utilize information associated with a location of user device 210 (e.g., global positioning system (GPS) coordinates of user device 210) to determine the event or the event location.

In some implementations, if the captured image includes a name associated with an event (e.g., a national championship football game) or an event location (e.g., Sunny Day Stadium), content server 220 may perform character recognition of the captured image in order to determine the name provided in the captured image. Content server 220 may compare the determined name with the names provided in data storage 225 in order to identify an event or an event location associated with the captured image. For example, if the determined name matches the name of a stadium provided in data storage 225, content server 220 may determine that the event location associated with the captured image is the stadium.

In some implementations, content server 220 may determine the event or the event location based on time information. For example, if the captured image includes a name of a hockey arena and it is Oct. 31, 2013 at 8:00 PM, content server 220 may determine that the event location is the hockey arena and that the event is a hockey being played two teams at the hockey arena on Oct. 31, 2013 at 8:00 PM.

In some implementations, content server 220 may determine an entity or entities (e.g., sports teams, a singer, a band, etc.) associated with the identified event or event location. For example, once content server 220 determines the event or the event location, content server 220 may utilize a date associated with the captured image or other information provided in the captured image (e.g., a team name provided on a scoreboard) to determine entit(ies) associated with the event or the event location. In some implementations, if the event is a championship baseball game, content server 220 may utilize the captured image to determine the baseball teams playing in the championship game. In some implementations, content server 220 may determine a particular team (e.g., the user's favorite team) playing in the event or at the event location based on a profile created for the user by application 510 (FIG. 5).

In some implementations, content server 220 may determine products, services, and/or content associated with the event, the event location, and/or the entit(ies). For example, once content server 220 determines the event, the event location, and/or the entit(ies), content server 220 may retrieve, from data storage 225, information associated with products, services, and/or content for the event, the event location, and/or the entit(ies). In some implementations, if the event is a football game between State University and City University at State University's stadium, content server 220 may retrieve (e.g., from data storage 225) information associated with products (e.g., State or City shirts, State or City hats, stadium concession locations, etc.), services (e.g., stadium bathroom locations, a stadium map, etc.), and/or content (e.g., videos of State University games, audio of City University games, etc.).

In some implementations, the products, services, and/or content associated with the event, the event location, and/or the entit(ies) may be available for purchase at the event location (e.g., within a stadium) and/or may be available for purchase online (e.g., via a web site). For example, if a particular team (e.g., the user's favorite team) wins the event (e.g., the national championship game), merchandise indicating that the particular team is the national champion may be available for purchase at the event location or online by the user.

As further shown in FIG. 10, process 1000 may include providing, to the user device, information associated with the products, services, and/or content available to purchase at the event location (block 1030). For example, content server 220 may provide, to user device 210, information associated with the products, the services, and/or the content available for purchase at the location event. In some implementations, if content server 220 determines that the event location is a football stadium where the user's favorite team (e.g., Computer State) is playing, content server 220 may provide, to user device 210, locations within the stadium where Computer State products (e.g., shirts, hats, sweatshirts, etc.) are available for purchase by the user. In some implementations, if content server 220 determines that the event location is a baseball stadium and that the captured image includes a hot dog, content server 220 may provide, to user device 210, locations within the stadium where hot dogs are available for purchase by the user. In some implementations, content server 220 may provide the user with directions from the user's current location to a location within the stadium where hot dogs are sold.

In some implementations, if content server 220 determines that the event location is a soccer stadium and that a soccer game being played in the stadium is being broadcast on television, content server 220 may provide, to user device 210, the television broadcast (e.g., for a fee or for free) of the soccer game or information associated with the television broadcast. This may enable the user to watch the soccer game live in the stadium as well as on user device 210 (e.g., for viewing replays during the soccer game).

In some implementations, if content server 220 determines that the event location is a home stadium of the Technical University football team, content server 220 may provide, to user device 210, information associated with available tickets for upcoming Technical University football games (e.g., that may be purchased at the stadium), season ticket prices for next year's football games, a game schedule for next year's football games, profiles of players for the Technical University football team, etc.

As further shown in FIG. 10, process 1000 may include providing, to the user device, information associated with the products, services, and/or content available to purchase online (block 1040). For example, content server 220 may provide, to user device 210, information associated with the products, the services, and/or the content available for purchase online. In some implementations, if content server 220 determines that the event location is a football stadium where the user's favorite team (e.g., Computer State) is playing, content server 220 may provide, to user device 210, a web site (e.g., a home page) dedicated to selling Computer State football merchandise, other web sites that offer Computer State football merchandise, etc.

In some implementations, if content server 220 determines that the event location is a concert hall and that the captured image includes a logo of wireless telephone provider (e.g., provided on a large screen television at the concert hall), content server 220 may provide, to user device 210, an advertisement associated with the wireless telephone provider, a web page associated with services of the wireless telephone provider, etc.

In some implementations, if content server 220 determines that the event location is a historic stadium (e.g., Fenway Park), content server 220 may provide, to user device 210, information associated with the history of the stadium, a web site (e.g., a home page) dedicated to selling merchandise associated with the stadium, etc.

Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

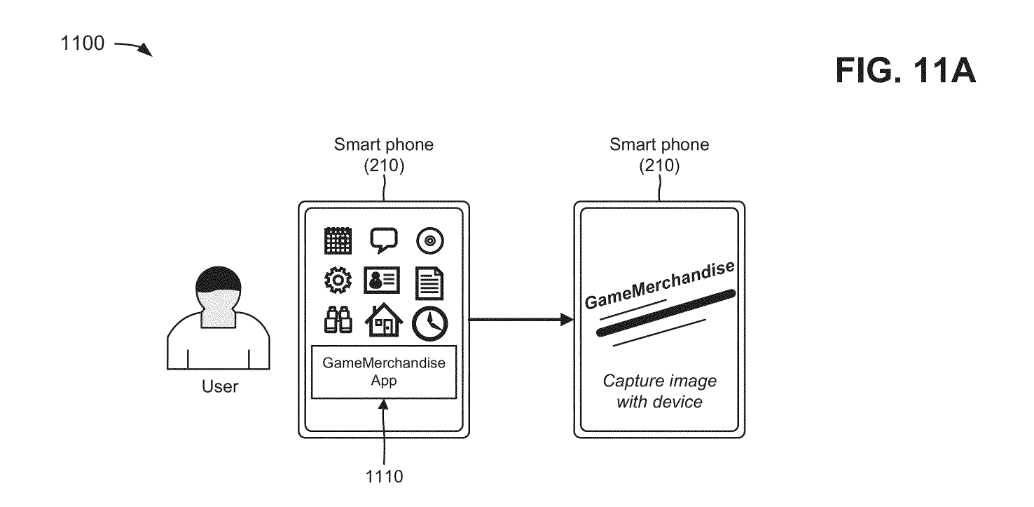

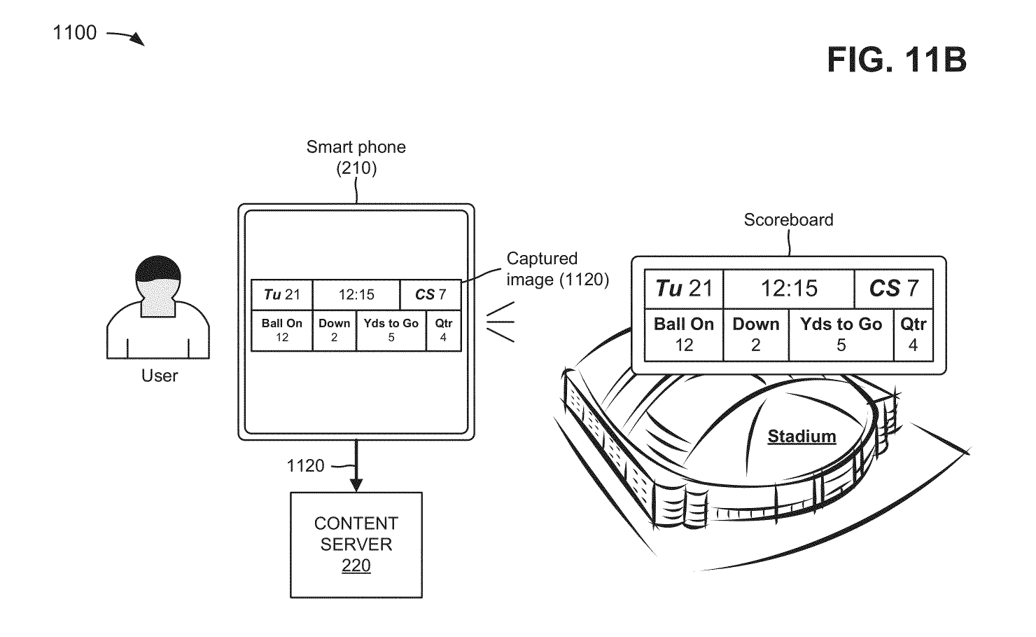

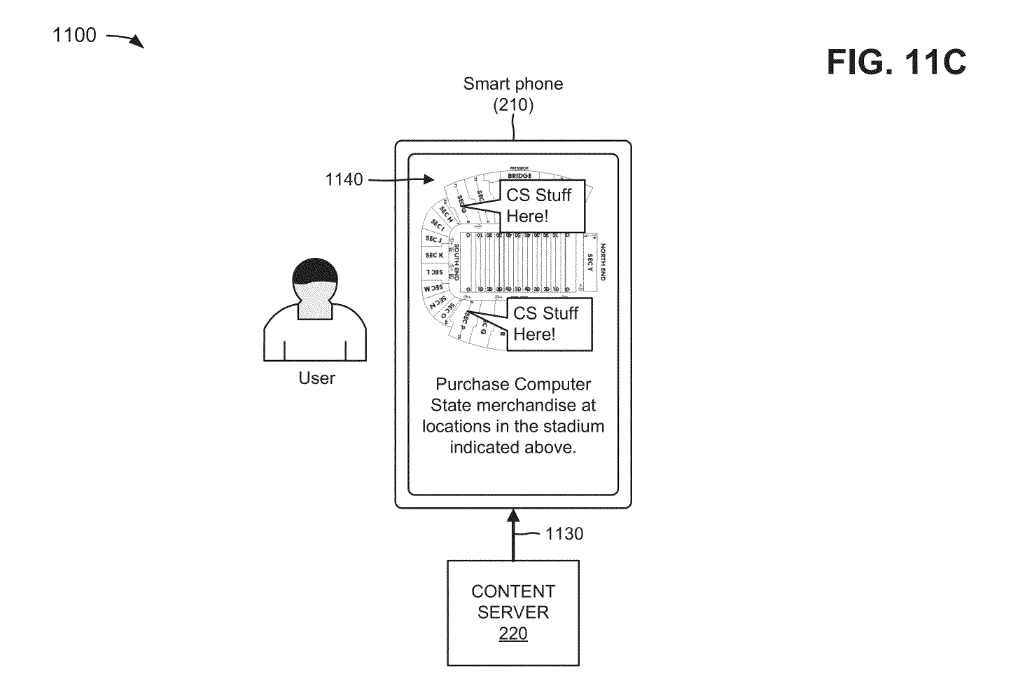

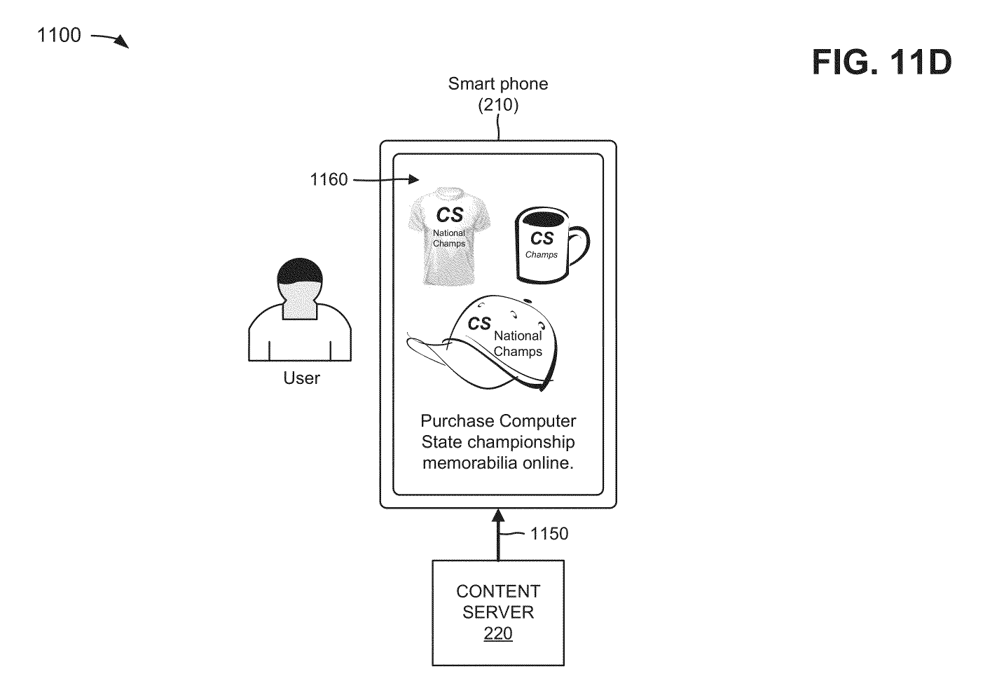

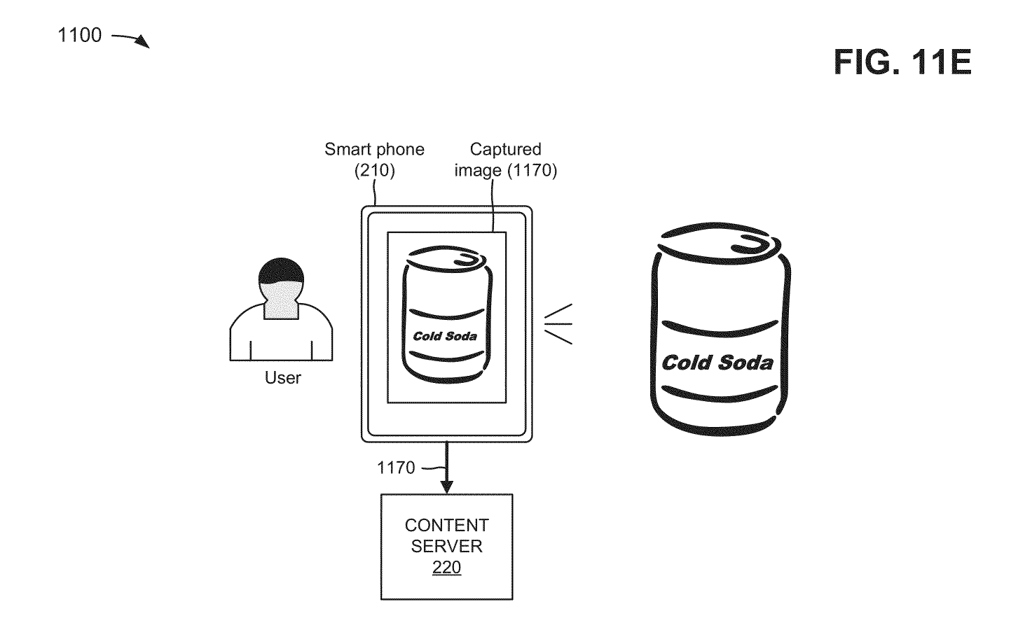

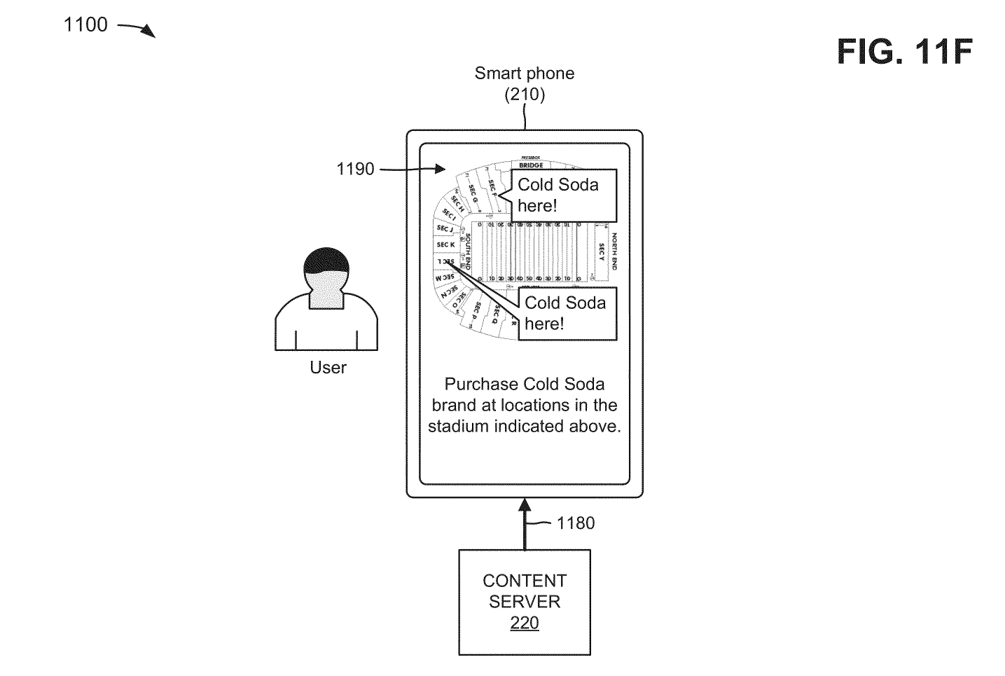

FIGS. 11A-11F are diagrams of an example 1100 relating to example process 1000 shown in FIG. 10. In example 1100, assume that a user is associated with user device 210 (e.g., a smart phone 210), as shown in FIG. 11A. Further, assume that that user utilizes smart phone 210 to select a GameMerchandise application (app) 1110 (e.g., the GameMerchandise portion of application 510, FIG. 5) stored in smart phone 210. When the user selects GameMerchandise application 1110, application 1110 may cause smart phone 210 to display a home page for GameMerchandise application 1110. As further shown in FIG. 11A, the home page may instruct the user to capture an image with smart phone 210 (e.g., with a camera of smart phone 210).

As shown in FIG. 11B, assume that the user is located at a stadium where a football game is being played between Technical University (TU) and Computer State (CS). Further, assume that the user utilizes the camera of smart phone 210 to view and capture a scoreboard provided in the stadium. Smart phone 210 may display a captured image 1120 of the scoreboard to the user, as further shown in FIG. 11B. GameMerchandise application 1110 may cause smart phone 210 to provide captured image 1120 to content server 220, and content server 220 may receive captured image 1120.

Content server 220 may determine an event (e.g., the football game between Technical University and Computer State), an event location (e.g., the stadium), and entities (e.g., Technical University and Computer State football teams) based on captured image 1120 of the scoreboard. For example, content server 220 may recognize the names of Technical University and Computer State from captured image 1120, and may determine the event (e.g., the football game) and the event location (e.g., the stadium) based on a time associated with the captured image 1120.

In some implementations, content server 220 may determine that the user is a fan of Computer State (e.g., based on a profile of the user), and may retrieve information associated with products, services, and/or content of Computer State that are available for purchase in the stadium. For example, content server 220 may retrieve information 1130 associated with products of Computer State that are available for purchase in the stadium, and may provide information 1130 to smart phone 210, as shown in FIG. 11C. As further shown in FIG. 11C, smart phone 210 may display, to the user, information 1130 as a map of the stadium with locations showing where Computer State merchandise can be purchased in the stadium, as indicated by reference number 1140. This may enable the user to walk to the locations in the stadium and see and/or purchase Computer State merchandise. In some implementations, information 1130 may include directions from the user's current location to a location where Computer State merchandise may be purchased in the stadium.

In some implementations, content server 220 may retrieve information associated with products, services, and/or content of Computer State that are available for purchase online. For example, content server 220 may retrieve information 1150 associated with championship memorabilia of Computer State that is available for purchase online, and may provide information 1150 to smart phone 210, as shown in FIG. 11D. As further shown in FIG. 11D, smart phone 210 may display, to the user, information 1150 as images of Computer State championship memorabilia that may be purchased via smart phone 210, as indicated by reference number 1160. This may enable the user to view and/or purchase Computer State championship memorabilia online via smart phone 210 and while at the game.

Now assume that the user is walking through the stadium and sees a sign with a picture of a Cold Soda brand drink. Further, assume that the user utilizes the camera of smart phone 210 to view and capture the picture of the Cold Soda brand drink. Smart phone 210 may display a captured image 1170 of the Cold Soda brand drink to the user, as shown in FIG. 11E. GameMerchandise application 1110 may cause smart phone 210 to provide captured image 1170 to content server 220, and content server 220 may receive captured image 1170.

Content server 220 may determine an event location (e.g., the stadium) based on a location of smart phone 210, and may determine a product (e.g., the Cold Soda brand drink) based on the captured image 1170. For example, content server 220 may recognize the name of the Cold Soda brand drink from captured image 1170. Based on the determined event location (e.g., the stadium) and the determined product (e.g., the Cold Soda brand drink), content server 220 may retrieve information 1180 associated with the Cold Soda brand drink that is available for purchase in the stadium, and may provide information 1180 to smart phone 210, as shown in FIG. 11F. As further shown in FIG. 11F, smart phone 210 may display, to the user, information 1180 as a map of the stadium with locations showing where the Cold Soda brand drink can be purchased in the stadium, as indicated by reference number 1190. This may enable the user to walk to the locations in the stadium and purchase the Cold Soda brand drink.

In some implementations, the user utilize smart phone 210 to capture an image of a game ticket, while inside the stadium during the hours the event is occurring, and, based on the captured image, GameMerchandise application 1110 may enable the user to purchase concessions offered inside the stadium and have the concessions delivered to the user's seat. GameMerchandise application 1110 may know what game the user is attending and where the user is sitting since the user used the game ticket as the trigger (e.g., the captured image). GameMerchandise application 1110 may verify that the user is at the stadium, via GPS coordinates associated with smart phone 210, and may permit payment, so that once the order is placed, the user may wait for the concessions without having to leave the user's seat or pay a concessions vendor.

As indicated above. FIGS. 11A-11F are provided merely as an example. Other examples are possible and may differ from what was described with regard to FIGS. 11A-11F. In some implementations, the various operations described in connection with FIGS. 11A-11F may be performed automatically or at the request of the user.

Although a captured image is described herein as being a trigger for the functionality of application 510, in some implementations, the trigger for the functionality of application 510 may include a moving image, a video, audio, a person, a structure, a GPS location of user device 210, etc. For example, if the user stands, with user device 210, in the exact spot that Lee Harvey Oswald was believed to have shot John F. Kennedy (JFK), the location of user device 210 may be used as a trigger to display a video of JFK in a car, an audio clip of JFK's shooting, various images of JFK's presidency, etc.

To the extent the aforementioned implementations collect, store, or employ personal information provided by individuals, it should be understood that such information shall be used in accordance with all applicable laws concerning protection of personal information. Storage and use of personal information may be in an appropriately secure manner reflective of the type of information, for example, through various encryption and anonymization techniques for particularly sensitive information.

The foregoing disclosure provides illustration and description, but is not intended to be exhaustive or to limit the implementations to the precise form disclosed. Modifications and variations are possible in light of the above disclosure or may be acquired from practice of the implementations.

A component is intended to be broadly construed as hardware, firmware, or a combination of hardware and software.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A method, comprising:
receiving, by a device, an image captured by a user device,
the image being captured by the user device at an event or at an event location;
analyzing, by the device, the captured image to determine the event or the event location;
analyzing, by the device, the captured image to determine an entity associated with the event or the event location;
determining, by the device and based on the captured image, at least one of a product, a service, or content associated with at least one of the event, the event location, or the entity; and
providing, by the device and to the user device, information associated with the at least one of the product, the service, or the content,
the information identifying a location at the event location from which to purchase the at least one of the product, the service, or the content.

2. The method of claim 1, where the information associated with the at least one of the product, the service, or the content further identifies a web site from which to purchase the at least one of the product, the service, or the content.

3. The method of claim 1, where analyzing the captured image to determine the event or the event location comprises one of:
performing image recognition of the captured image to determine the event or the event location; or
performing character recognition of the captured image to determine the event or the event location.

4. The method of claim 1, where, prior to receiving the image captured by the user device, the method further comprises:
receiving a request for an application from the user device,
the application enabling the user device to provide the captured image to the device;
providing the application to the user device based on the request;
receiving, from the user device, information identifying preferences for the application; and
providing, to the user device, configuration information for the application based on the information identifying the preferences,
the user device configuring the application based on the configuration information.

5. The method of claim 4, where analyzing the captured image to determine the entity associated with the event or the event location further comprises:
determining the entity based on the configuration information for the application.

6. The method of claim 1, further comprising:
identifying, based on the captured image, an upcoming event associated with the entity;
determining a title, a date, a time, and broadcast information associated with the upcoming event;
providing, to the user device, the title, the date, the time, and the broadcast information associated with the upcoming event; and
providing, to the user device, one or more of:
an option to watch a broadcast of the upcoming event,
an option to listen to the broadcast of the upcoming event,
an option to record the broadcast of the upcoming event, or
an option to provide a reminder about the upcoming event.

7. The method of claim 1, further comprising:
providing, to the user device, an audio file and audio lyrics associated with the entity;
providing, to the user device, a video associated with the entity; or
providing, to the user device, another audio file of announcers for the video.

8. The method of claim 1, further comprising:
providing, to the user device, an event image of a particular event associated with the entity,
the event image including a portion that enables the user device to capture another image and to combine the captured other image with the event image to form a combined image, and
the combined image being capable of being shared by the user device with other user devices.

9. The method of claim 1, further comprising:
determining at least one of a product, a service, or content associated with the entity;
providing, to the user device, information associated with the at least one of the product, the service, or the content;
determining a sponsor for the entity; and
providing, to the user device, information associated with the sponsor for the entity.

10. A device, comprising:
one or more processors to:
receive an image captured by a user device,
the image being captured by the user device at an event or at an event location, and
the image being captured at a particular time and at a particular location by the user device,
determine the event or the event location based on the captured image, the particular time, and the particular location,
analyze the captured image to determine an entity associated with the event or the event location,
determine, based on the captured image, at least one of a product, a service, or content associated with at least one of the event, the event location, or the entity, and
provide, to the user device, information associated with the at least one of the product, the service, or the content,
the information identifying at least one location at the event location from which to purchase the at least one of the product, the service, or the content.

11. The device of claim 10, where the information associated with the at least one of the product, the service, or the content further identifies a web site from which to purchase the at least one of the product, the service, or the content.

12. The device of claim 10, where, when determining the event or the event location based on the captured image, the particular time, and the particular location, the one or more processors are further to one of:
perform image recognition of the captured image to determine the event or the event location, or
perform character recognition of the captured image to determine the event or the event location.

13. The device of claim 10, where the one or more processors are further to:
identify, based on the captured image, an upcoming event associated with the entity,
determine a title, a date, a time, and broadcast information associated with the upcoming event,
provide, to the user device, the title, the date, the time, and the broadcast information associated with the upcoming event, and
provide, to the user device, one or more of:
an option to watch a broadcast of the upcoming event,
an option to listen to the broadcast of the upcoming event,
an option to record the broadcast of the upcoming event, or
an option to provide a reminder about the upcoming event.

14. The device of claim 10, where the one or more processors are further to:
provide, to the user device, an audio file and audio lyrics associated with the entity,
provide, to the user device, a video associated with the entity, or
provide, to the user device, another audio file of announcers for the video.

15. The device of claim 10, where the one or more processors are further to:
provide, to the user device, an event image of a particular event associated with the entity,
the event image including a portion that enables the user device to capture another image and to combine the captured other image with the event image to form a combined image, and
the combined image being capable of being shared by the user device with other user devices.

16. The device of claim 10, where the one or more processors are further to:
determine at least one of a product, a service, or content associated with the entity,
provide, to the user device, information associated with the at least one of the product, the service, or the content,
determine a sponsor for the entity, and
provide, to the user device, information associated with the sponsor for the entity.

17. A non-transitory computer-readable medium for storing instructions, the instructions comprising:
one or more instructions that, when executed by one or more processors of a device, cause the one or more processors to:
receive an image captured by a user device,
the image being captured by the user device at an event or at an event location, and
the image being captured at a particular time and at a particular location by the user device,
determine the event or the event location based on the captured image, the particular time, and the particular location,
analyze the captured image to determine an entity associated with the event or the event location,
determine, based on the captured image, at least one of a product, a service, or content associated with at least one of the event, the event location, or the entity, and
provide, to the user device, information associated with the at least one of the product, the service, or the content,
the information identifying at least one location at the event location from which to purchase the at least one of the product, the service, or the content, and
the information further identifying a web site from which to purchase the at least one of the product, the service, or the content.

18. The computer-readable medium of claim 17, where the instructions further comprise:
one or more instructions that, when executed by the one or more processors, cause the one or more processors to:
perform image recognition of the captured image to determine the event or the event location, or
perform character recognition of the captured image to determine the event or the event location.

19. The computer-readable medium of claim 17, where the instructions further comprise:
one or more instructions that, when executed by the one or more processors, cause the one or more processors to:
identify, based on the captured image, an upcoming event associated with the entity,
determine a title, a date, a time, and broadcast information associated with the upcoming event,
provide, to the user device, the title, the date, the time, and the broadcast information associated with the upcoming event, and
provide, to the user device, one or more of:
an option to watch a broadcast of the upcoming event,
an option to listen to the broadcast of the upcoming event,
an option to record the broadcast of the upcoming event, or
an option to provide a reminder about the upcoming event.

20. The computer-readable medium of claim 17, where the instructions further comprise:
one or more instructions that, when executed by the one or more processors, cause the one or more processors to:
provide, to the user device, an audio file and audio lyrics associated with the entity,
provide, to the user device, a video associated with the entity, or
provide, to the user device, another audio file of announcers for the video.

21. The computer-readable medium of claim 17, where the instructions further comprise:
one or more instructions that, when executed by the one or more processors, cause the one or more processors to:
provide, to the user device, an event image of a particular event associated with the entity,
the event image including a portion that enables the user device to capture another image and to combine the captured other image with the event image to form a combined image, and
the combined image being capable of being shared by the user device with other user devices.

22. The computer-readable medium of claim 17, where the instructions further comprise:
one or more instructions that, when executed by the one or more processors, cause the one or more processors to:
determine at least one of a product, a service, or content associated with the entity,
provide, to the user device, information associated with the at least one of the product, the service, or the content,
determine a sponsor for the entity, and
provide, to the user device, information associated with the sponsor for the entity.
